(19) United States
(12) Patent Application Publication
(10) Pub. No.: US 2024/0181506 A1
(43) Pub. Date: Jun. 6, 2024

(54) DRAIN TANK CLEANING SYSTEM FOR AN APPLIANCE

(71) Applicant: Sub-Zero Group, Inc., Madison, WI (US)

(72) Inventor: John Paul Gilles, Madison, WI (US)

(21) Appl. No.: 18/060,625

(22) Filed: Dec. 1, 2022

(51) Int. Cl. B08B 9/093; A47L 15/00; F24C 14/00; F25C 1/00

(52) U.S. Cl. CPC B08B 9/093; A47L 15/0057; F24C 14/005; F25C 1/00; B08B 2209/08; F25C 2400/12

(57) ABSTRACT

A drain control system receives a first indicator of start of a cleaning cycle. In response to receipt of the first indicator, a signal is sent to turn on a drain pump mounted within a drain tank to evacuate a fluid stored in the drain tank when the drain tank is not indicated as empty. A second indicator is received that a cleaning fluid has been provided to a storage tank. After the drain tank is indicated as empty, circulation of the cleaning fluid is controlled within a drain system. The drain system drains the cleaning fluid into the drain tank after circulating within the drain system. The drain pump is controlled to turn on to evacuate the cleaning fluid from the drain tank based on a fluid level indicator generated by a fluid level sensor after the cleaning fluid drains into the drain tank.

### BACKGROUND

Cleaning fluid may be provided to various appliances to clean, descale, and/or sanitize portions of the appliance. For example, residential ice machines commonly have a drain tank connected to collect water from the ice maker. A drain pump may be mounted in the drain tank to evacuate water from the drain tank. Typically, the drain tank also includes a water level sensor, such as a float switch, that activates the drain pump when the water reaches a high-water state. The drain pump may be deactivated automatically when the water level sensor indicates a low-water state such that the drain pump can be isolated from other system controls and simply activate and deactivate in direct response to the water level state as indicated by the water level sensor. Buildup may form on the walls of the drain tank, the drain tank sensors, the pump motor, etc. adversely affecting operation of the drain system and causing drain components to fail. However, the automatic operation of the drain pump may not support adequate cleaning of the drain tank.

### SUMMARY

In an example embodiment, a computer-readable medium is provided having stored thereon computer-readable instructions that when executed by a drain control system, cause the drain control system to control draining of fluid from a drain system. A first indicator of start of a cleaning cycle is received. In response to receipt of the first indicator, a signal is sent to turn on a drain pump mounted within a drain tank to evacuate a fluid stored in the drain tank when the drain tank is not indicated as empty. A second indicator is received that a cleaning fluid has been provided to a storage tank. After the drain tank is indicated as empty, circulation of the cleaning fluid is controlled within a drain system. The drain system is configured to drain the cleaning fluid into the drain tank after circulating within the drain system. The drain pump is controlled to turn on to evacuate the cleaning fluid from the drain tank based on a fluid level indicator generated by a fluid level sensor after the cleaning fluid drains into the drain tank.

In another example embodiment, an appliance is provided. The appliance includes, but is not limited to, a storage tank, a drain tank, a drain pump mounted within the drain tank, a fluid level sensor configured to measure a fluid level of a fluid in the drain tank, a drain system configured to direct the fluid from the storage tank to the drain tank, and a drain controller that includes, but is not limited to, a processor and a computer-readable medium operably coupled to the processor. The computer-readable medium has instructions stored thereon that, when executed by the processor, cause the drain controller to control draining of fluid from the drain system.

Other principal features of the disclosed subject matter will become apparent to those skilled in the art upon review of the following drawings, the detailed description, and the appended claims.

### BRIEF DESCRIPTION OF THE DRAWINGS

Illustrative embodiments of the disclosed subject matter will hereafter be described referring to the accompanying drawings, wherein like numerals denote like elements.

FIG. 1 depicts a right, front perspective view of an ice maker assembly in accordance with an illustrative embodiment.

FIG. 2 depicts a right, front perspective view of the ice maker assembly of FIG. 1 with a door removed in accordance with an illustrative embodiment.

FIG. 3A depicts a left, back perspective view of a base compartment of the ice maker assembly of FIG. 2 in accordance with an illustrative embodiment.

FIG. 3B depicts a right, back perspective view of the base compartment of FIG. 3A with walls removed in accordance with an illustrative embodiment.

FIG. 4 depicts a right, back perspective view of the ice maker assembly of FIG. 2 with walls and an ice bin removed in accordance with an illustrative embodiment.

FIG. 5 depicts a right, front perspective view of the ice maker assembly of FIG. 2 with a cleaning fluid drawer in a fully open position in accordance with an illustrative embodiment.

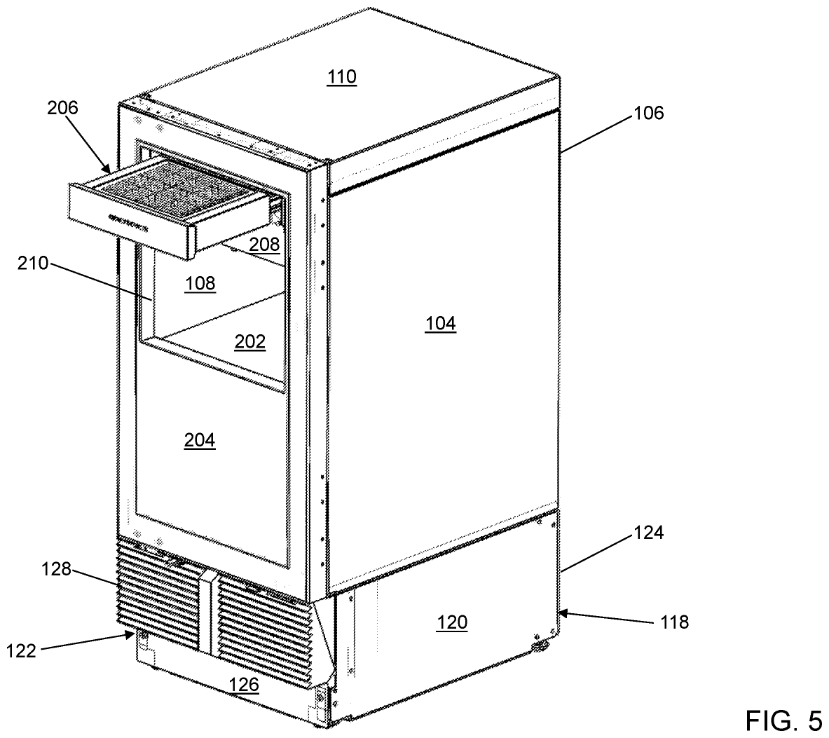

FIG. 6A depicts a right, front perspective view of the cleaning fluid drawer and an ice maker of the ice maker assembly of FIG. 1 with the cleaning fluid drawer in the fully open position in accordance with an illustrative embodiment.

FIG. 6B depicts a right perspective cross-sectional view of the cleaning fluid drawer and the ice maker of FIG. 6A with the cleaning fluid drawer in the fully open position in accordance with an illustrative embodiment.

FIG. 7A depicts a right, front perspective view of the ice maker of FIG. 6A in accordance with an illustrative embodiment.

FIG. 7B depicts a right, back perspective view of the ice maker of FIG. 7A in accordance with an illustrative embodiment.

FIG. 8A depicts a right, front perspective view of ice making components of the ice maker of FIG. 7A in accordance with an illustrative embodiment.

FIG. 8B depicts a left perspective view of the ice making components of FIG. 8A in accordance with an illustrative embodiment.

FIG. 8C depicts a bottom perspective view of the ice making components of FIG. 8A in accordance with an illustrative embodiment.

FIG. 9 depicts a left, front perspective view of a sump housing of the ice maker of FIG. 7A in accordance with an illustrative embodiment.

FIG. 10A depicts a top, left, front perspective view of the ice maker assembly housing in accordance with an illustrative embodiment.

FIG. 10B depicts a bottom, left, front cross-sectional view of the ice maker assembly housing of FIG. 10A in accordance with an illustrative embodiment.

FIG. 10C depicts a top, left, front cross-sectional view of the ice maker assembly housing of FIG. 10A in accordance with an illustrative embodiment.

FIG. 10D depicts a bottom, right, front view of a portion of the ice maker assembly housing of FIG. 10A in accordance with an illustrative embodiment.

FIG. 11 depicts a right, front perspective view of the base compartment of FIG. 3A with a right sidewall and a drain tank removed in accordance with an illustrative embodiment.

FIG. 12A depicts a top, right perspective view of the drain tank of the ice maker assembly of FIG. 1 in accordance with an illustrative embodiment.

FIG. 12B depicts a bottom, left perspective view of the drain tank of FIG. 12A in accordance with an illustrative embodiment.

FIG. 13 depicts a right, back perspective view of the base compartment of FIG. 3A with sidewalls and drain tank sidewalls removed in accordance with an illustrative embodiment.

FIG. 14A depicts a top, left perspective view of a drain tank cover and drain pump of the ice maker assembly of FIG. 1 in accordance with an illustrative embodiment.

FIG. 14B depicts a bottom, left perspective view of the drain tank cover and drain pump of FIG. 14A in accordance with an illustrative embodiment.

FIG. 14C depicts a bottom, back, right perspective view of the drain tank cover and drain pump of FIG. 14A in accordance with an illustrative embodiment.

FIG. 15 depicts a block diagram of a drain system controller of the ice maker assembly of FIG. 1 in accordance with an illustrative embodiment.

FIG. 16 depicts a flow diagram illustrating examples of operations performed by the drain system controller of FIG. 15 in accordance with an illustrative embodiment.

### DETAILED DESCRIPTION

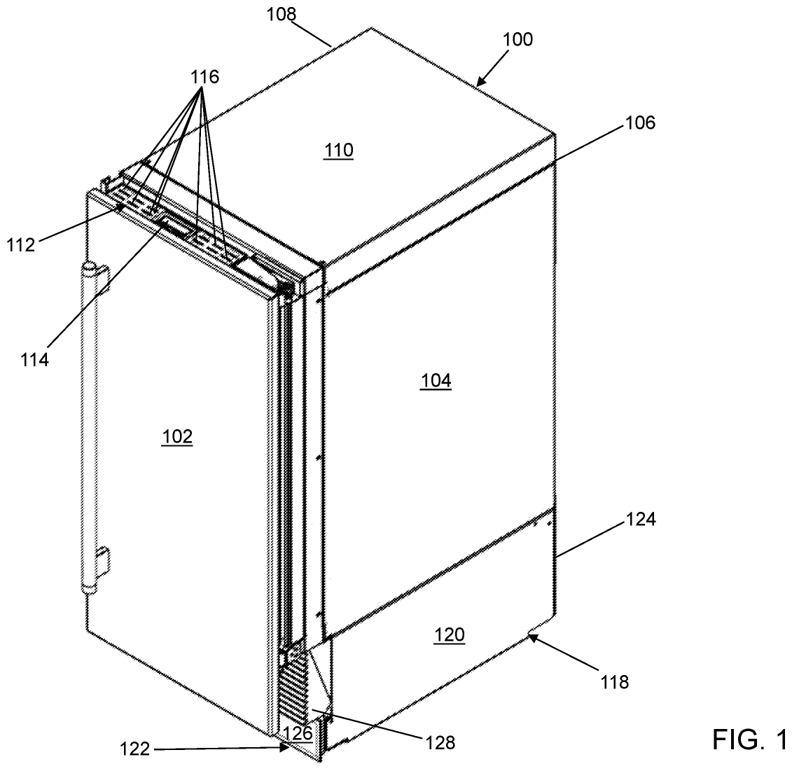

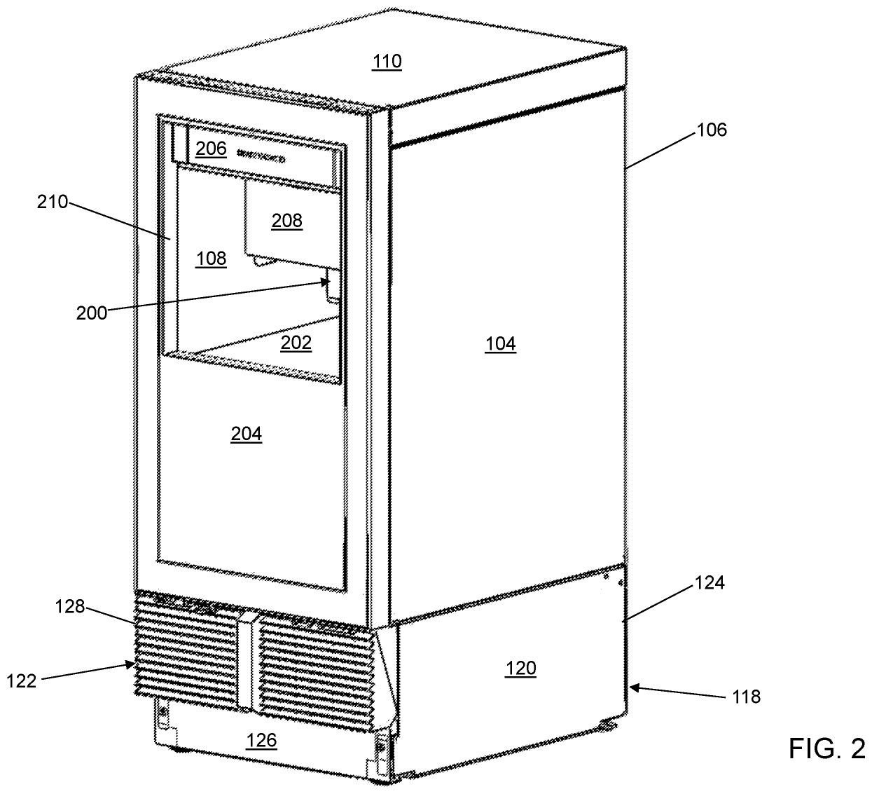

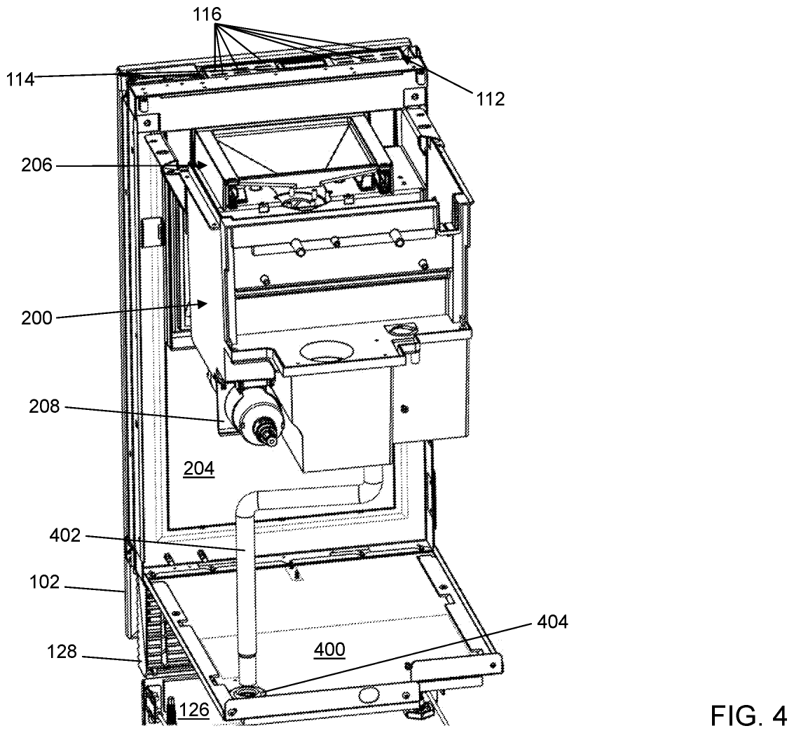

Referring to FIG. 1, a right, front perspective view of an ice maker assembly 100 is shown in accordance with an illustrative embodiment. Referring to FIG. 2, a right, front perspective view of ice maker assembly 100 with a door 102 removed is shown in accordance with an illustrative embodiment. In the illustrative embodiment, ice maker assembly 100 is a standalone ice making machine that includes an ice maker 200 that makes ice and directs the ice for storage in a bin 202 positioned below ice maker 200. Ice maker assembly 100 may include door 102, a right side wall 104, a back wall 106, a left side wall 108, a top wall 110, a bottom wall 400 (shown referring to FIG. 4A), a control panel 112, and a base compartment 118. In the illustrative embodiment, control panel 112 includes a display 114 and a plurality of control buttons 116. A user of ice maker assembly 100 may control one or more operations of ice maker assembly 100 through selection of one or more buttons of the plurality of control buttons 116 and/or through interaction with display 114 that may be a touchscreen that presents information to the user as well as allows the user to make selections.

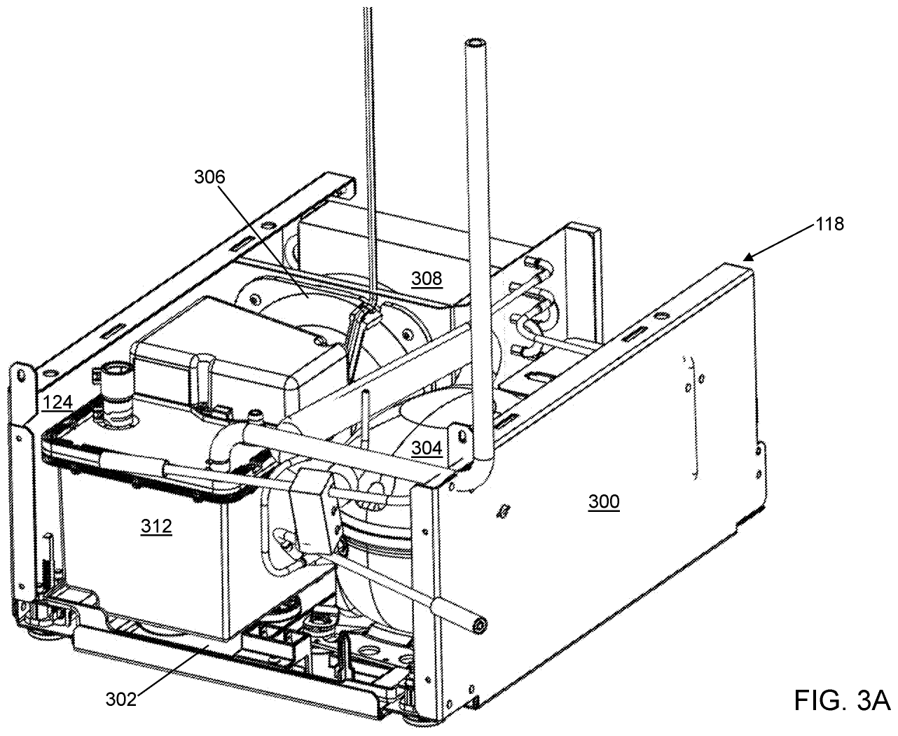

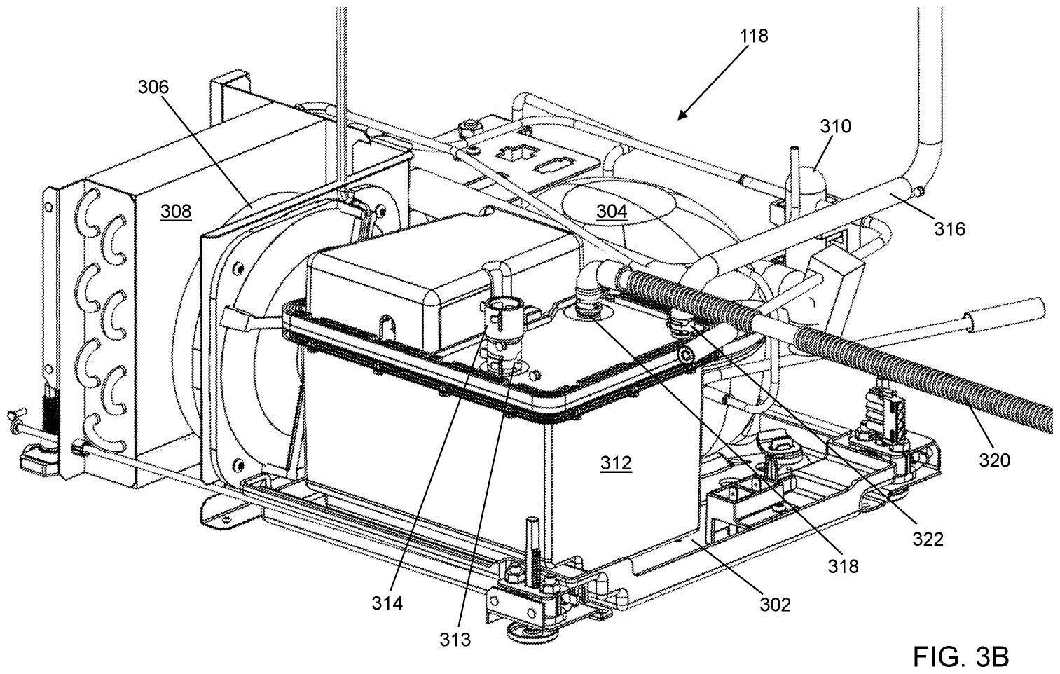

Base compartment 118 may include a right side wall 120, a left side wall 300 (shown referring to FIG. 3A), a front wall 122, a back wall 124, and a bottom wall 302 (shown referring to FIG. 3A). Front wall 122 may include a kick plate 126 mounted below a vent wall 128 that allows air to circulate within base compartment 118.

In the illustrative embodiment, door 102 is rotatably mounted to a bin front wall 204 using two hinges. In an alternative embodiment, door 102 may be rotatably mounted to different walls of ice maker assembly 100 using a fewer or a greater number of hinges. In an alternative embodiment, ice maker assembly 100 may not include a door 102. Kick plate 126 and vent wall 128 are mounted below bin front wall 204.

Door 102 provides access to bin 202 that holds ice. In the illustrative embodiment, a cleaning fluid drawer 206, an ice backstop 208, and ice maker 200 may be mounted adjacent top wall 110. Bin front wall 204 may include an aperture wall 210 that defines an opening through which ice may be withdrawn from bin 202 by a user. In the illustrative embodiment, aperture wall 210 defines a rectangular opening though other shapes may be used to define the aperture through which ice is withdrawn. In the illustrative embodiment, cleaning fluid drawer 206 is mounted at a top of aperture wall 210 and is recessed from a plane defined by a front face of bin front wall 204 though cleaning fluid drawer 206 may be mounted to other locations on ice maker assembly 100 and may not be recessed. When door 102 is in a closed position, door 102 covers bin front wall 204 such that ice cannot be withdrawn from bin 202.

As understood by a person of skill in the art, the walls and door 102 that form ice maker assembly 100 are insulated walls that include insulation to assist in maintenance of a desired temperature within a cavity defined by the walls of ice maker assembly 100 such as within bin 202. Electrical wiring and various conduits may further be located in the insulated walls. For example, during a manufacturing process, a space between exterior walls of ice maker assembly 100 and an interior liner may be filled with an insulating foam material that provides insulation. Electrical wiring and/or conduits for fluid may be mounted within the space as well. The exterior walls and interior liner may together define a wall such that a wall may be formed of multiple layers made or one or more materials of the same or a different type.

Use of directional terms, such as top, bottom, right, left, front, back, etc. are merely intended to facilitate reference to the various surfaces and elements of the described structures relative to the orientations shown in the drawings and are not intended to be limiting in any manner. For consistency, the components of ice maker assembly 100 are labeled such that door 102 defines a front of ice maker assembly 100.

Though shown in the illustrative embodiment as forming a generally rectangular shaped enclosure, ice maker assembly 100 may form any shaped enclosure including other polygons as well as circular or elliptical enclosures. As a result, door 102, the walls forming ice maker assembly 100, and other components may have any shape including other polygons as well as circular or elliptical shapes.

Referring to FIG. 3A, a back, left perspective view of base compartment 118 is shown with front wall 122 and back wall 124 removed in accordance with an illustrative embodiment. Referring to FIG. 3B, a back, right perspective view of base compartment 118 is shown with all of the walls except bottom wall 302 removed in accordance with an illustrative embodiment.

Base compartment 118 provides a housing for some of the refrigeration components of ice maker assembly 100. Base compartment 118 is mounted below bottom wall 400 though base compartment 118 may be positioned at alternative locations in alternative embodiments. For example, base compartment 118 may be mounted above top wall 110 or behind back wall 106 in alternative embodiments. In the illustrative embodiment, bottom wall 400 forms a top wall of base compartment 118. Vent wall 128 includes louvers mounted across a face thereof to provide a flow of ambient air across the refrigeration components of ice maker assembly 100 mounted within base compartment 118.

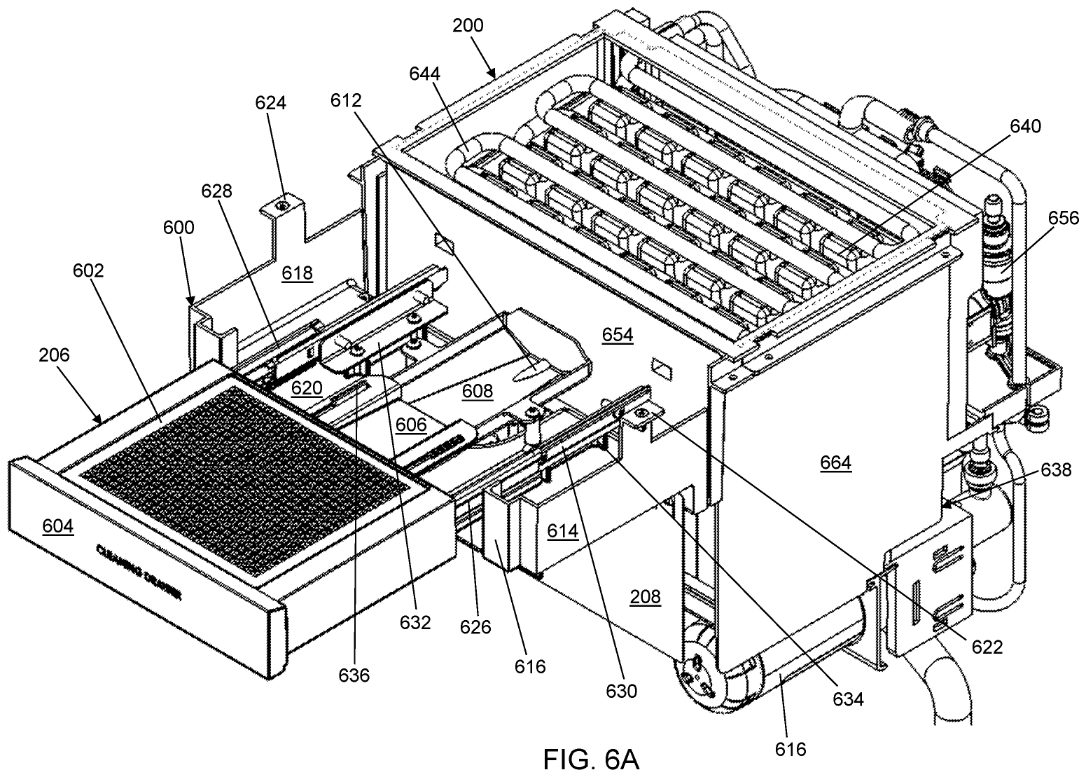

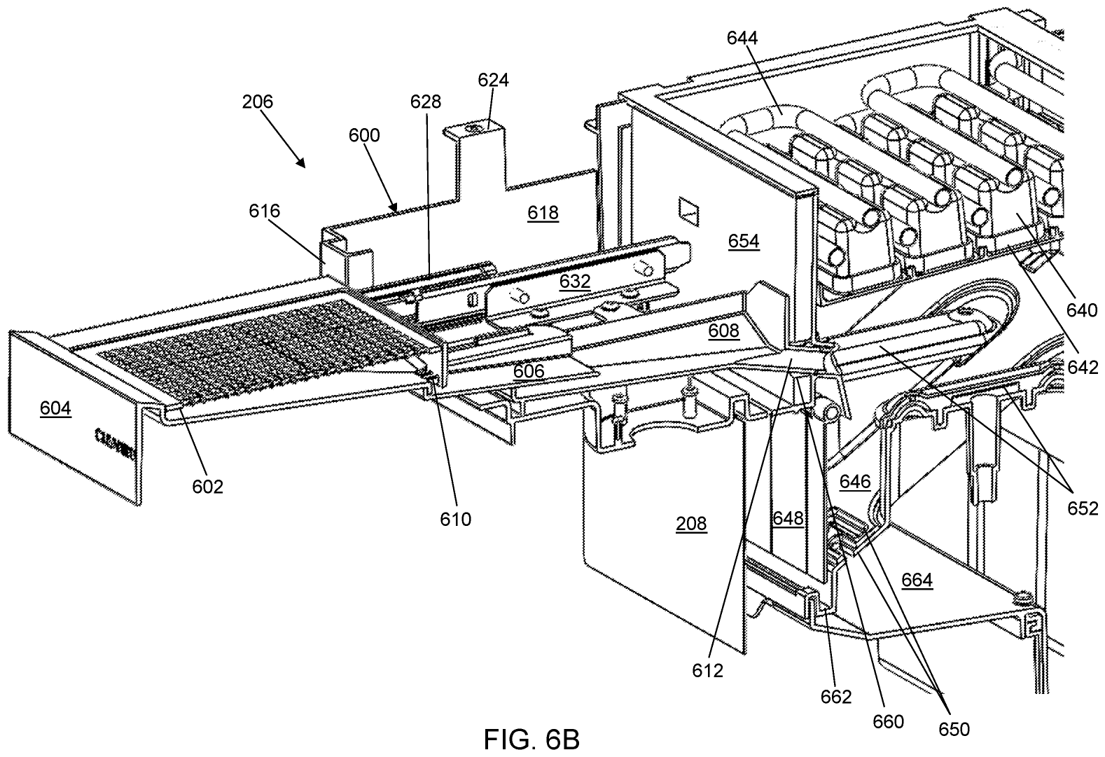

The refrigeration components of ice maker assembly 100 cool an ice mold 640 (shown referring to FIG. 6A) to a temperature that promotes the formation of ice as understood by a person of skill in the art. The refrigeration components may be mounted to various walls of ice maker assembly 100 either within the walls, on an exterior of the walls relative to ice maker assembly 100, and/or on an interior of the walls relative to ice maker assembly 100. For example, the refrigeration components mounted within base compartment 118 may include a compressor 304, a fan 306, an condenser 308, a drier 310, etc. Additional refrigeration components may be mounted closer to ice maker 200 as described further below. Various tubing may connect the refrigeration components to provide a refrigeration cycle as understood by a person of skill in the art.

A drain tank 312 may further be mounted within base compartment 118 and connected using various conduits to receive fluid into or to evacuate fluid from drain tank 312. For example, a tank intake connector 313 may be connected to receive fluid from ice maker 200 using a tank connector 314. An outtake conduit 320 may be connected to drain tank 312 using a tank outtake connector 318. Fluid is evacuated from drain tank 312 through an outtake conduit 320 and transported to an exterior drain (not shown). An air conduit 316 may be connected to receive air or to expel air from drain tank 312 using a tank air connector 322 depending on whether fluid is being evacuated from drain tank 312 or being received into drain tank 312.

Referring to FIG. 4, a back, right perspective view of ice maker assembly 100 is shown with right side wall 104, back wall 106, left side wall 108, and top wall 110 removed in accordance with an illustrative embodiment. A drain aperture wall 404 is formed through bottom wall 400 to accommodate a connection between a sump drain conduit 402 and tank intake connector 312 of drain tank 312 as described further below.

Referring to FIG. 2, cleaning fluid drawer 206 is shown in a fully closed position. Referring to FIG. 4, a right, front perspective view of cleaning fluid drawer 206 is shown in a fully open position in accordance with an illustrative embodiment. When in the open position, cleaning fluid may be poured into cleaning fluid drawer 206. The cleaning fluid may be a descaling fluid or a sanitizing fluid used to clean ice maker 200, bin 202, and/or drain tank 312.

Referring to FIG. 6A, a right, front perspective view of cleaning fluid drawer 206 and ice maker 200 is shown with cleaning fluid drawer 206 in a fully open position in accordance with an illustrative embodiment. Referring to FIG. 6B, a right perspective cross-sectional view of cleaning fluid drawer 206 and ice maker 200 is shown with cleaning fluid drawer 206 in the fully open position in accordance with an illustrative embodiment. Cleaning fluid drawer 206 may include a drawer base 600, a splash guard tray 602, a drawer 604, a transition tray 606, and a bottom tray 608. Drawer base 600 mounts cleaning fluid drawer 206 to ice maker assembly 100. For example, drawer base 600 mounts cleaning fluid drawer 206 to an interior side of top wall 110 of ice maker assembly 100. Drawer 604 is slidably mounted to drawer base 600. Bottom tray 608 is mounted to drawer base 600 so that bottom tray 608 does not slide with drawer 604. Transition tray 606 is mounted between drawer 604 and bottom tray 608 in a stacked manner such that splash guard tray 602 is mounted above drawer 604, drawer 604 is mounted above transition tray 606, and transition tray 606 is mounted above bottom tray 608.

A top drawer drain 610 is located on a floor of drawer 604 to provide a drain for fluid poured into drawer 604. The fluid travels through or over top drawer drain 610 onto a floor of transition tray 606 and/or onto a floor of bottom tray 608. A drain tube 612 is mounted to extend from the floor of bottom tray 608. Drain tube 612 receives the fluid poured into drawer 604 and provides a conduit to transport the fluid to an intended location within ice maker 200.

Drawer base 600 may include a support right sidewall 614, a support front wall 616, a support left sidewall 618, and a support bottom wall 620, a right mounting arm 622, and a left mounting arm 624. A finger depression wall (not shown) may be formed in support bottom wall 620 to facilitate insertion of a finger of a user to grab drawer 604 and pull drawer 604 away from support front wall 616. Right mounting arm 622 has an L-shape and extends upward away from a top edge of support right sidewall 614. Left mounting arm 624 has an L-shape and extends upward away from a top edge of support left sidewall 618. A first fastener may be inserted through a top tab of right mounting arm 622, and a second fastener may be inserted through a top tab of left mounting arm 624 to mount drawer base 600 to the interior surface of top wall 110. Other mounting mechanisms may be used in alternative embodiments to fixedly mount drawer base 600 to ice maker assembly 100 in an orientation to allow withdrawal of drawer 604 from drawer base 600. In the illustrative embodiment, support front wall 616 is split into a right portion and a left portion to define an aperture within which drawer 604 is slid.

In the illustrative embodiment, cleaning fluid drawer 206 is slid outward using a right slide 626 and a left slide 628 mounted to an inner surface of a right side of drawer 604 and an inner surface of a left side of drawer 604, respectively. Other sliding mechanisms may be used in alternative embodiments. For example, cleaning fluid drawer 206 may be slid outward using a track formed on or in support bottom wall 620.

Right slide 626 is mounted to a right slide mounting brace 630, and left slide 628 is mounted to a left slide mounting brace 632. Right slide mounting brace 630 is mounted to a right support platform 634 that is mounted to support bottom wall 620. Left slide mounting brace 632 is mounted to a left support platform 636 that is mounted to support bottom wall 620. In the illustrative embodiments, fasteners are used to mount the slides to a respective slide mounting brace and to mount the slide mounting braces to a respective support platform though other mounting mechanisms may be used in alternative embodiments.

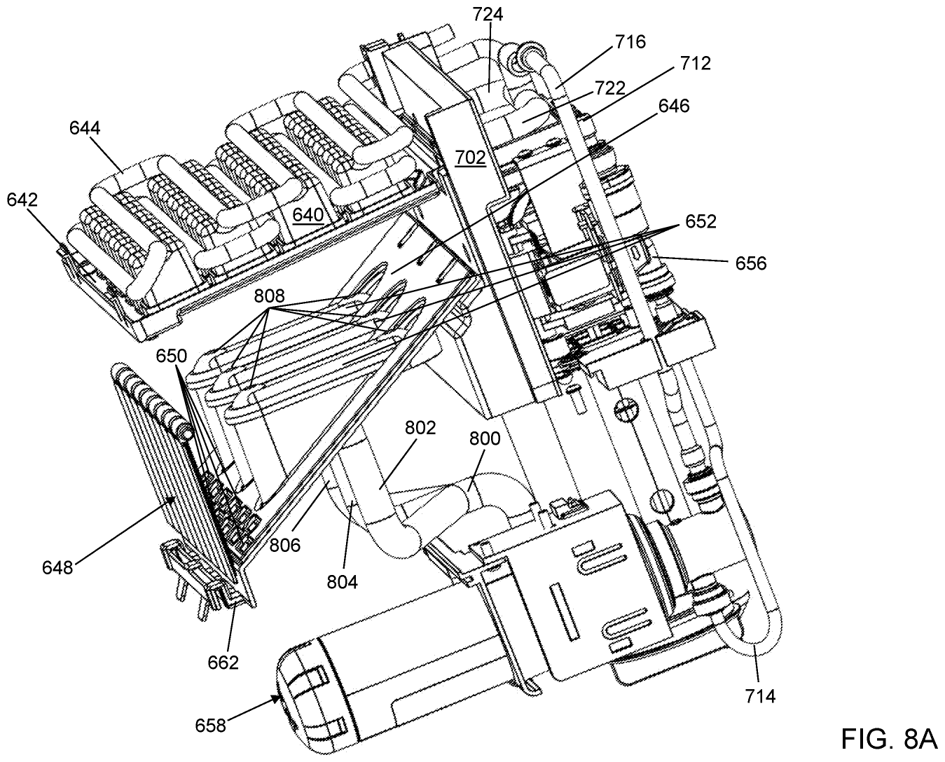

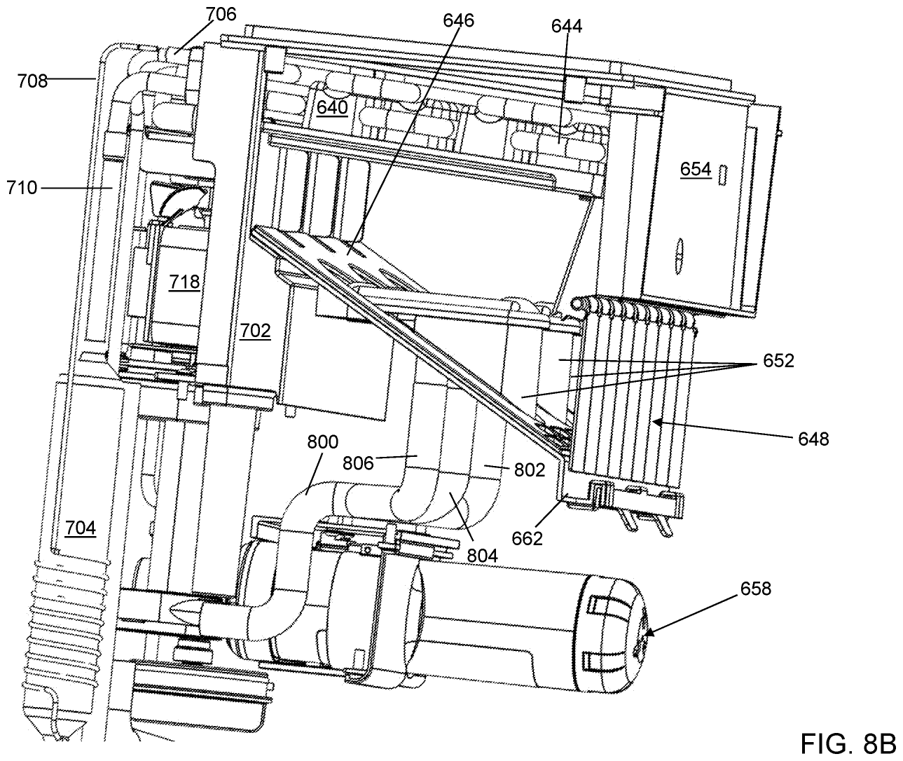

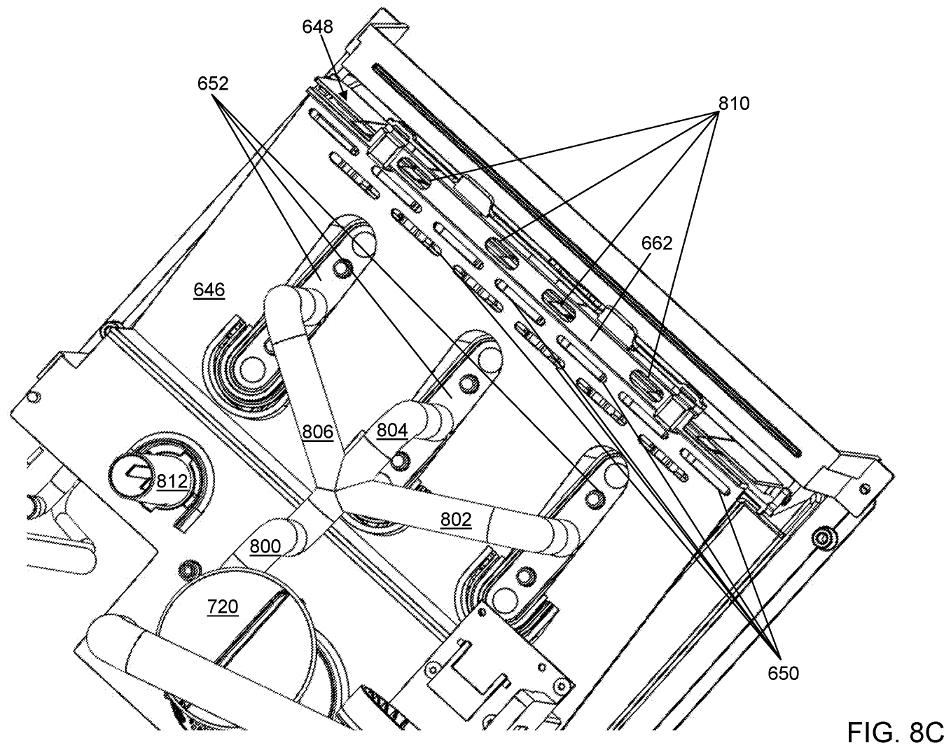

Ice maker 200 may include a sump housing 638, an ice mold 640, a mold tray 642, an evaporator coil 644, an ice chute 646, curtain fingers 648, drain aperture walls 650, a plurality of sprayers 652, a cover 654, a valve 656, and a filter assembly 658. An ice chute drip channel 662 is a channel formed across a front edge of ice chute 646. A drain aperture wall 660 is formed through cover 654 and is positioned to align with drain tube 612 when bottom tray 608 is mounted to ice maker 200. The fluid poured into drawer 604 flows through drain aperture wall 660 and into an interior of ice maker 200 that may be referred to as a sump. Channel drain aperture walls 810 (shown referring to FIG. 8C) are formed through a bottom of ice chute drip channel 662.

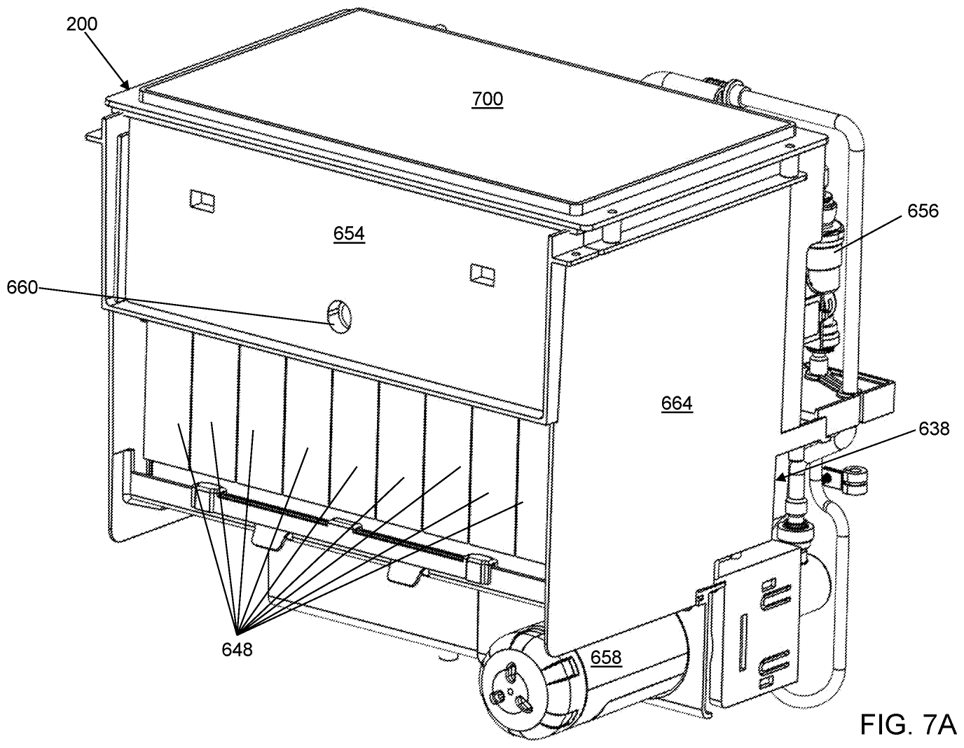

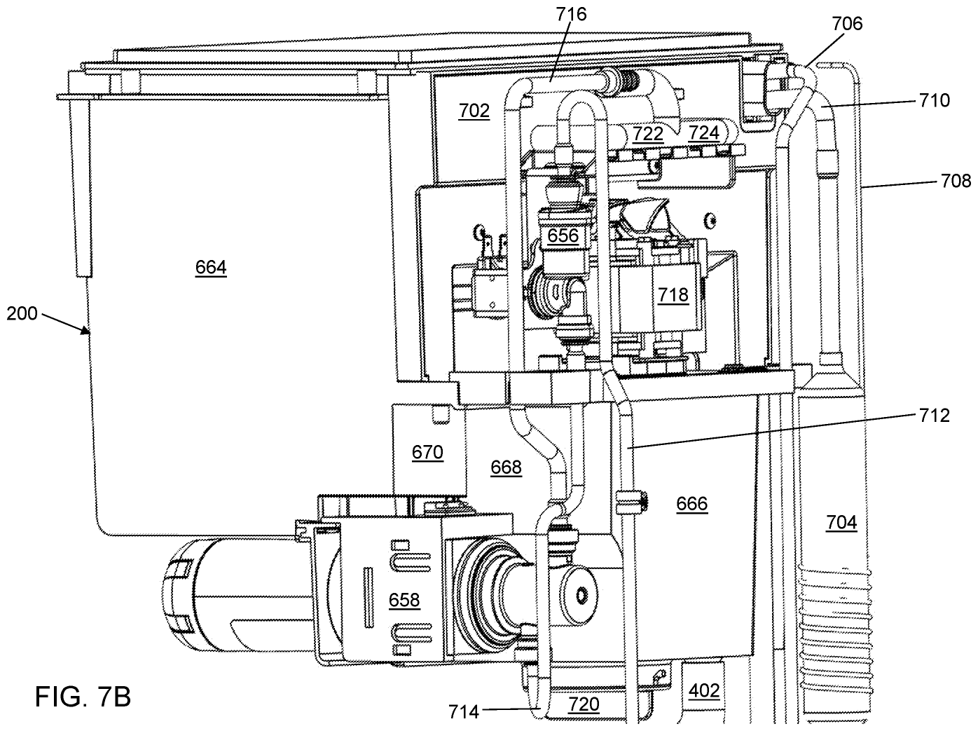

Referring to FIG. 7A, a right, front perspective view of ice maker 200 is shown in accordance with an illustrative embodiment. Referring to FIG. 7B, a right, back perspective view of ice maker 200 is shown in accordance with an illustrative embodiment. A housing for ice maker 200 may include sump housing 638, an ice maker top wall 700, cover 654, curtain fingers 648, and an ice maker back wall 702.

Ice maker 200 further may include an accumulator 704, a warm refrigerant intake conduit 706, a refrigerant intake conduit 708, a refrigerant outtake conduit 710, a water intake conduit 712, a filter intake conduit 714, a filtered water conduit 716, a sump fluid pump 718, a drain cap 720, a first ice mold intake conduit 722, and a second ice mold intake conduit 724. In an alternative embodiment, ice maker 200 may not include filter assembly 658.

Warm refrigerant intake conduit 706 may be connected to receive warm refrigerant from compressor 304. Warm refrigerant intake conduit 706 is connected to provide the warm refrigerant to evaporator coil 644 to trigger release of ice from ice mold 640. Refrigerant intake conduit 708 may be connected to receive refrigerant from condenser 308. Refrigerant intake conduit 708 is connected to provide the refrigerant to evaporator coil 644 to chill ice mold 640 thereby forming the ice in ice mold 640. Refrigerant outtake conduit 710 is connected to receive the refrigerant from evaporator coil 644 after cooling ice mold 640.

Accumulator 704 is mounted to receive refrigerant from refrigerant outtake conduit 710 to prevent liquid refrigerant from reaching compressor 304 that is designed to move vapor refrigerant in the form of a gas. As a result, accumulator 704 is connected to provide the refrigerant in the form of a gas to compressor 304. Compressor 304 is connected to provide the refrigerant to condenser 308 that condenses the gaseous refrigerant back to a liquid state. Drier 310 is connected between condenser 308 and refrigerant intake conduit 708. Fan 306 is mounted to cool condenser 308. An ice maker controller (not shown) may control a flow of refrigerant through condenser 308, drier 310, evaporator coil 644, accumulator 704, and compressor 304 to control a temperature of ice mold 640 and a temperature within bin 202.

Referring to FIG. 8A, a right, front perspective view of ice making components of ice maker 200 are shown in accordance with an illustrative embodiment. Referring to FIG. 8B, a left, front perspective view of the ice making components are shown in accordance with an illustrative embodiment. Referring to FIG. 8C, a bottom perspective view of the ice making components are shown in accordance with an illustrative embodiment. Sump housing 638 has been removed so that the ice making components are visible.

Evaporator coil 644 forms a two-level serpentine pattern above a top of each ice piece mold of ice mold 640 and between each row of molds of ice mold 640. For example, in the illustrative embodiment, ice mold 640 includes four rows of generally rectangular molds with six molds in each row to form 24 ice pieces. Each mold may form other shapes and be larger or smaller than those shown in the illustrative embodiment. Ice mold 640 may form a greater or a fewer number of ice pieces in alternative embodiments. Each ice piece may be formed to have a variety of shapes including spheres, cylinders, multi-sided polygons, etc. The size of the ice piece is further not intended to be limiting

Ice mold 640 is formed using a material that can be kept at or below freezing by evaporator coil 644 to form the ice pieces. Illustrative materials include stainless steel and copper with or without plating. Ice mold 640 is surrounded by mold tray 642. Mold tray 642 includes mold aperture walls within which each mold of ice mold 640 fits. Mold tray 642 slopes downward toward a front of ice maker 200.

A sprayer conduit 800 is connected to receive water from sump fluid pump 718 that pumps water from a sump cavity into sprayer conduit 800. Sprayer conduit 800 splits into a first sprayer conduit 802, a second sprayer conduit 804, and a third sprayer conduit 806. Each sprayer conduit is connected to a different sprayer of the plurality of sprayers 652. For example, in the illustrative embodiment, the plurality of sprayers 652 includes three sprayers. First sprayer conduit 802 is connected to a first sprayer of the plurality of sprayers 652. Second sprayer conduit 804 is connected to a second sprayer of the plurality of sprayers 652. Third sprayer conduit 806 is connected to a third sprayer of the plurality of sprayers 652. There may be a greater or a fewer number of sprayers of the plurality of sprayers 652, for example, based on dimensions of ice mold 640.

The plurality of sprayers 652 include a plurality of nozzles 808. In the illustrative embodiment, each sprayer includes a pair of nozzles of the plurality of nozzles 808. There may be a greater or a fewer number of nozzles in each sprayer, for example, based on dimensions of ice mold 640 and a size of a spray cone generated by each nozzle. Each ice piece mold of ice mold 640 is open downwards toward the plurality of sprayers 652. Each nozzle sprays water upward into ice mold 640.

To form ice, valve 656 is connected to receive water or another type of fluid in an alternative embodiment. Valve 656 controls a flow of the water from water intake conduit 712 into filter intake conduit 714 that is connected between valve 656 and filter assembly 658. Filter assembly 658 filters the water and provides the filtered water to filtered water conduit 716 that is connected to first ice mold intake conduit 722 and second ice mold intake conduit 724 that extend through aperture walls formed through ice maker back wall 702 and open onto mold tray 642.

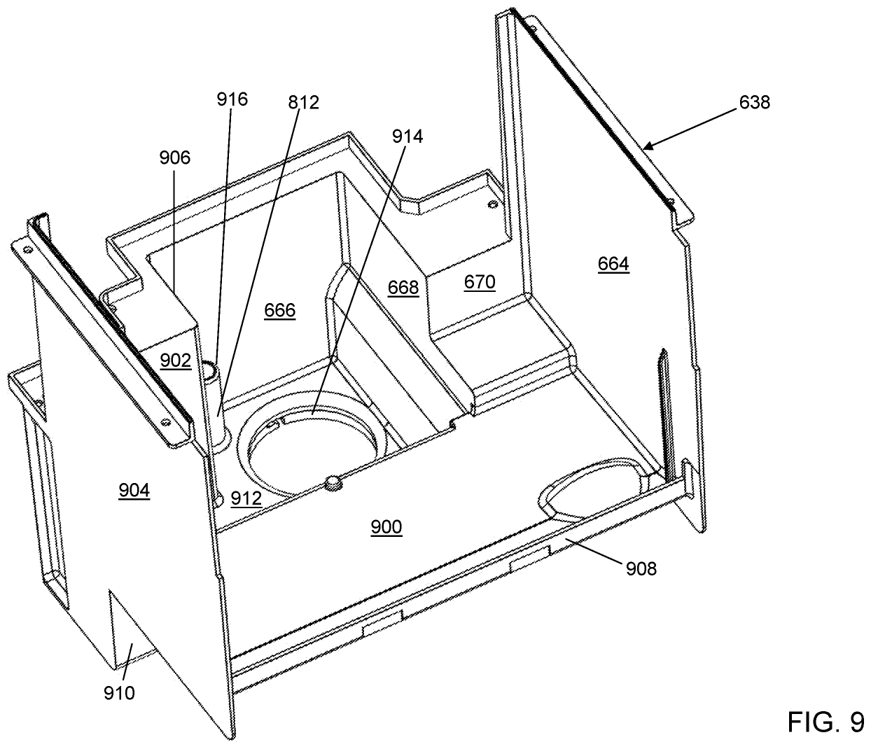

The water from first ice mold intake conduit 722 and second ice mold intake conduit 724 flows down mold tray 642 through apertures (not shown) formed in a front of mold tray 642. The water from mold tray 642 flows down through drain aperture walls 650 of ice chute 646 and channel drain aperture walls 810 of ice chute drip channel 662 onto an upper sump bottom wall 900 (shown referring to FIG. 9) and downward into the sump cavity where it can be pumped by sump fluid pump 718 into sprayer conduit 800. In particular, water striking curtain fingers 648 flows down into ice chute drip channel 662 and through channel drain aperture walls 810 onto upper sump bottom wall 900. Curtain fingers 648 primarily keep the water from flowing exterior of ice maker 200.

Sprayer conduit 800 splits the water pumped by sump fluid pump 718 into first sprayer conduit 802, second sprayer conduit 804, and third sprayer conduit 806 that are each connected to a respective sprayer of the plurality of sprayers 652. Each nozzle of the plurality of nozzles 808 sprays the water upward into ice mold 640 to form the ice pieces as the sprayed water freezes. Unfrozen water falls back onto ice chute 646 and flows down through drain aperture walls 650 of ice chute 646 and channel drain aperture walls 810 of ice chute drip channel 662 onto upper sump bottom wall 900 and downward into the sump cavity where it can again be pumped by sump fluid pump 718 into sprayer conduit 800. The ice pieces formed by ice maker 200 may be referred to as “clear ice” due to a reduction in minerals trapped in the ice pieces. Minerals not removed by filter assembly 658 collect in a bottom of the sump cavity.

Once the ice maker controller determines that sufficient water has been provided to form the ice pieces, valve 656 is switched closed to stop the flow of water into filter assembly 658 or directly into filtered water conduit 716 when ice maker 200 does not include filter assembly 658. Once the ice maker controller determines that formation of the ice pieces is complete, the ice maker controller triggers a release of the ice pieces from ice mold 640. For example, warm refrigerant may be provided through warm refrigerant intake conduit 706 to release the ice from ice mold 640. The ice pieces travel by gravity down ice chute 646 through curtain fingers 648 and into bin 202.

Referring to FIG. 9, a left, front perspective view of sump housing 638 is shown in accordance with an illustrative embodiment. Sump housing 638 may include upper sump bottom wall 900, an upper sump right side wall 664, a lower sump right side wall 668, a right sump back wall 670, a center sump back wall 666, a left sump back wall 902, an upper sump left side wall 904, a lower sump left side wall 906, a sump front lip 908, a lower sump front wall 910, a lower sump bottom wall 912, a sump drain cap aperture wall 914, and a sump overflow drain tube 812. Cover 654 mounts to an upper portion of upper sump right side wall 664 and of upper sump left side wall 904. Curtain fingers 648 are mounted just behind sump front lip 908 to block water from exiting the sump cavity when ice is being formed. Upper sump bottom wall 900 slopes downward toward lower sump bottom wall 912 to feed fluid into a lower portion of the sump cavity. Upper sump right side wall 664 and lower sump right side wall 668 form a right sidewall of ice maker 200. Upper sump left side wall 904 and lower sump left side wall 906 form a left sidewall of ice maker 200. Right sump back wall 668, center sump back wall 666, and left sump back wall 902 mount to ice maker back wall 702 and form a lower portion of a back wall of ice maker 200 below ice maker back wall 702. Lower sump front wall 910, lower sump right side wall 668, center sump back wall 666, lower sump left side wall 906, left sump back wall 902, and lower sump bottom wall 912 form the sump cavity.

Sump drain cap aperture wall 914 is formed through lower sump bottom wall 912. Drain cap 720 is sized and shaped to mount to sump drain cap aperture wall 914. Drain cap 720 can be removed to empty any fluid or solid materials that accumulate in the sump cavity formed by sump housing 638.

An overflow drain tube 812 extends through lower sump bottom wall 912. A first portion of overflow drain tube 812 extends above lower sump bottom wall 912, and a second portion of overflow drain tube 812 extends below lower sump bottom wall 912 as shown in FIG. 8C. Overflow drain tube 812 provides a sump overflow drain that may be connected to sump drain conduit 402 to receive excess water from within the sump cavity when the water level rises above a top edge 916 of overflow drain tube 812. For example, overflow drain tube 812 may be selected to extend above lower sump bottom wall 912 a height that is less than a height of lower sump front wall 910 to ensure that fluid does not overflow the sump cavity above lower sump front wall 910.

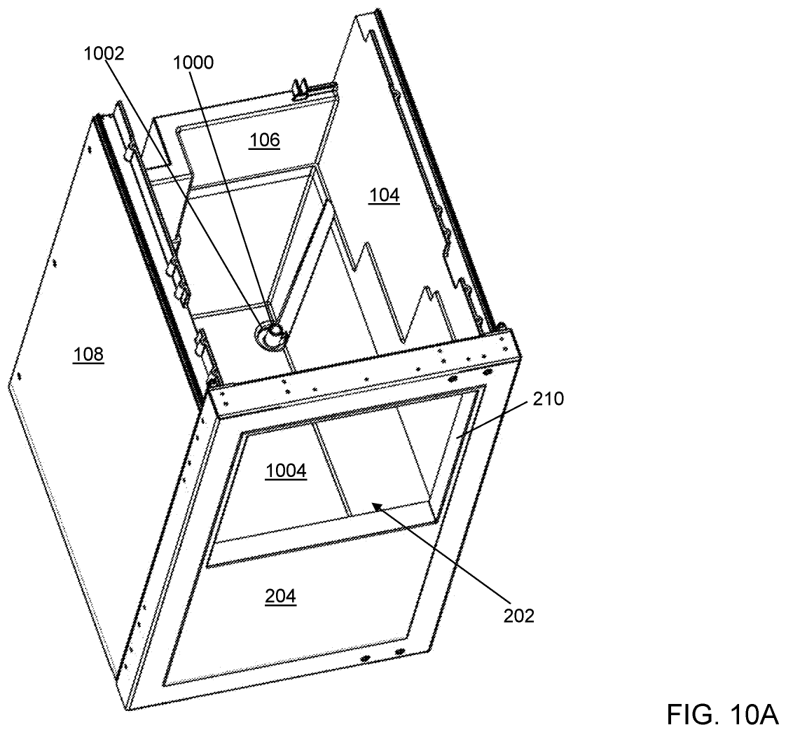

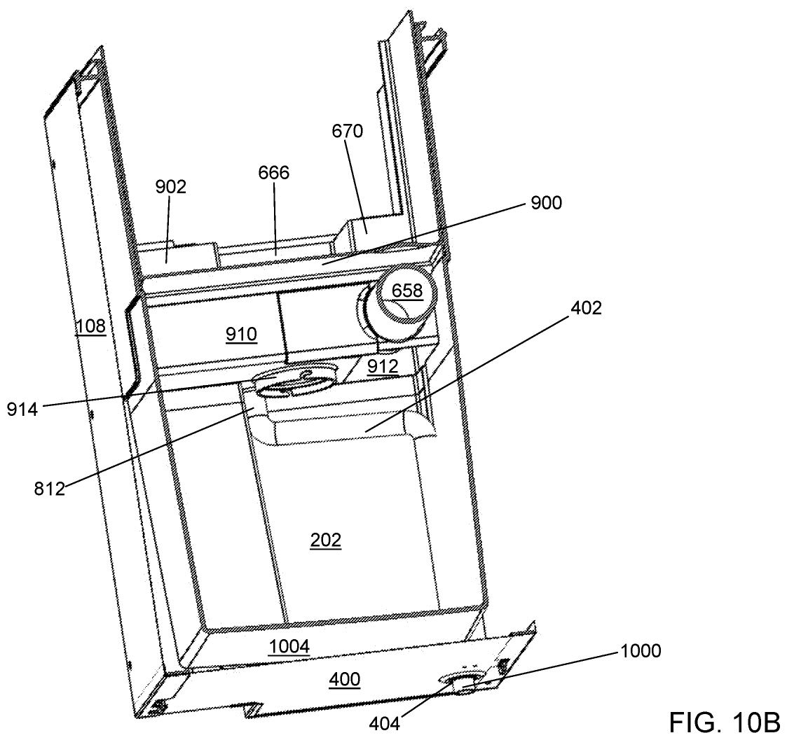

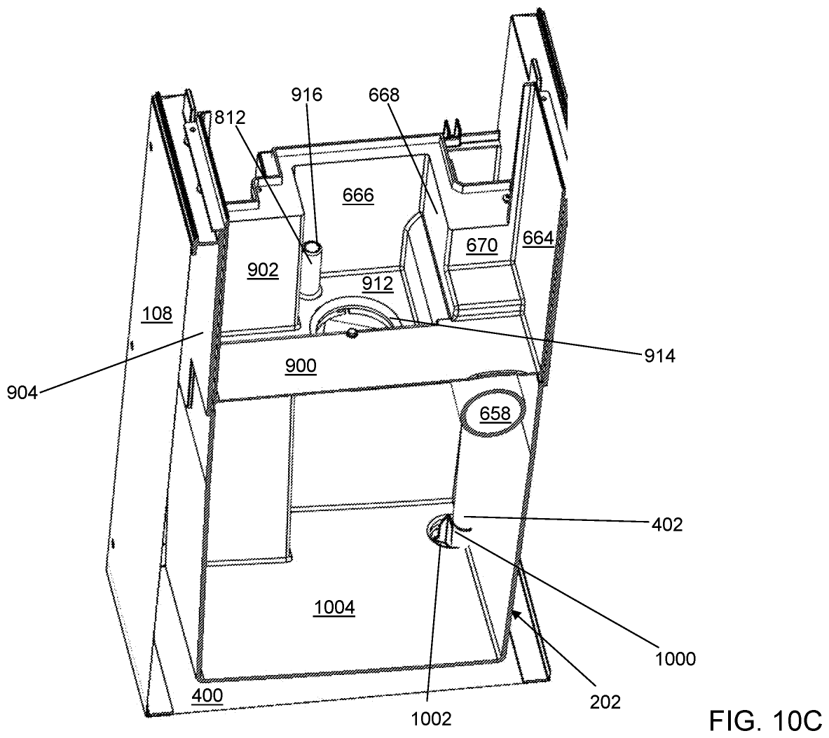

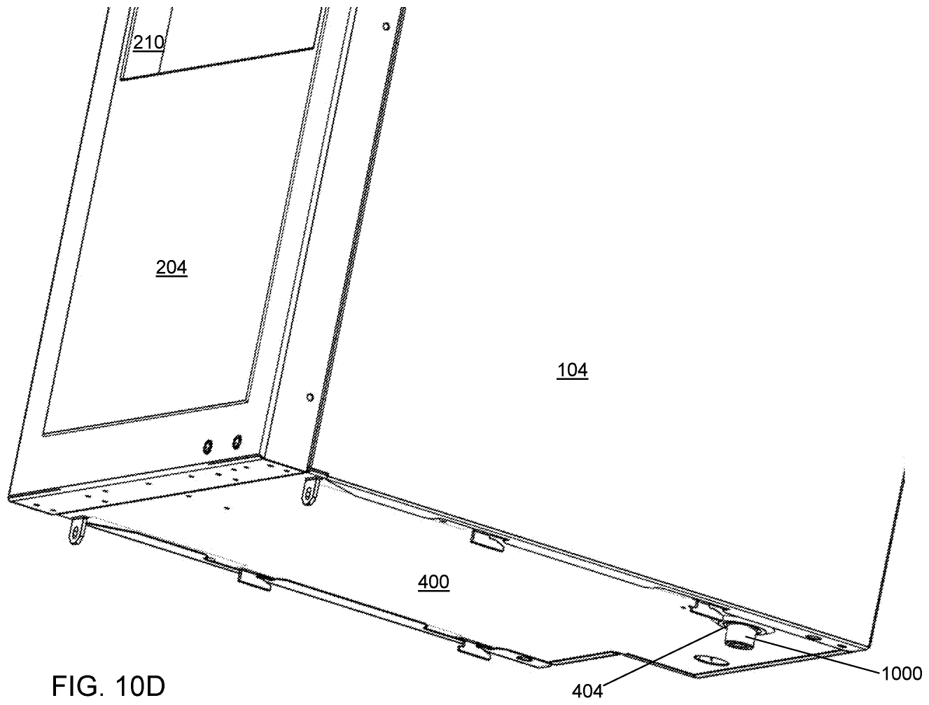

Referring to FIG. 10A, a top, left, front perspective view is shown of a portion of a housing of ice maker assembly 100 in accordance with an illustrative embodiment. Referring to FIG. 10B, a bottom, left, front cross-sectional view is shown of the ice maker assembly housing of FIG. 10A in accordance with an illustrative embodiment. Referring to FIG. 10C, a top, left, front cross-sectional view is shown of the ice maker assembly housing of FIG. 10A in accordance with an illustrative embodiment. Referring to FIG. 10D, a bottom, right, front view is shown of a portion of the ice maker assembly housing of FIG. 10A in accordance with an illustrative embodiment.

Overflow drain tube 812 is connected to sump drain conduit 402 at a first end. A drain connector tube 1000 is connected to sump drain conduit 402 at a second end opposite the first end within bin 202. A bin drain aperture wall 1002 is formed in a bottom wall 1004 of bin 202. Drain connector tube 1000 is inserted within bin drain aperture wall 1002 and extends through bottom wall 1004 of bin 202. Drain connector tube 1000 is also inserted within drain aperture wall 404 and extends through bottom wall 400.

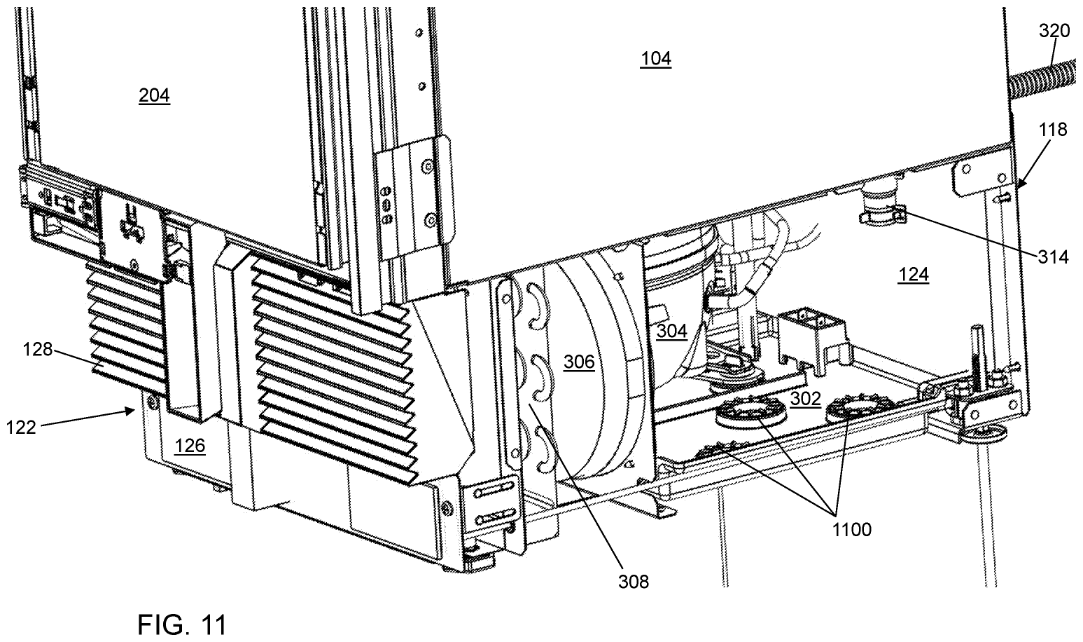

Referring to FIG. 11, a right, front perspective view is shown of base compartment 118 with right side wall 120 and drain tank 312 removed in accordance with an illustrative embodiment. Bottom wall connectors 1100 are mounted to a top surface of bottom wall 302.

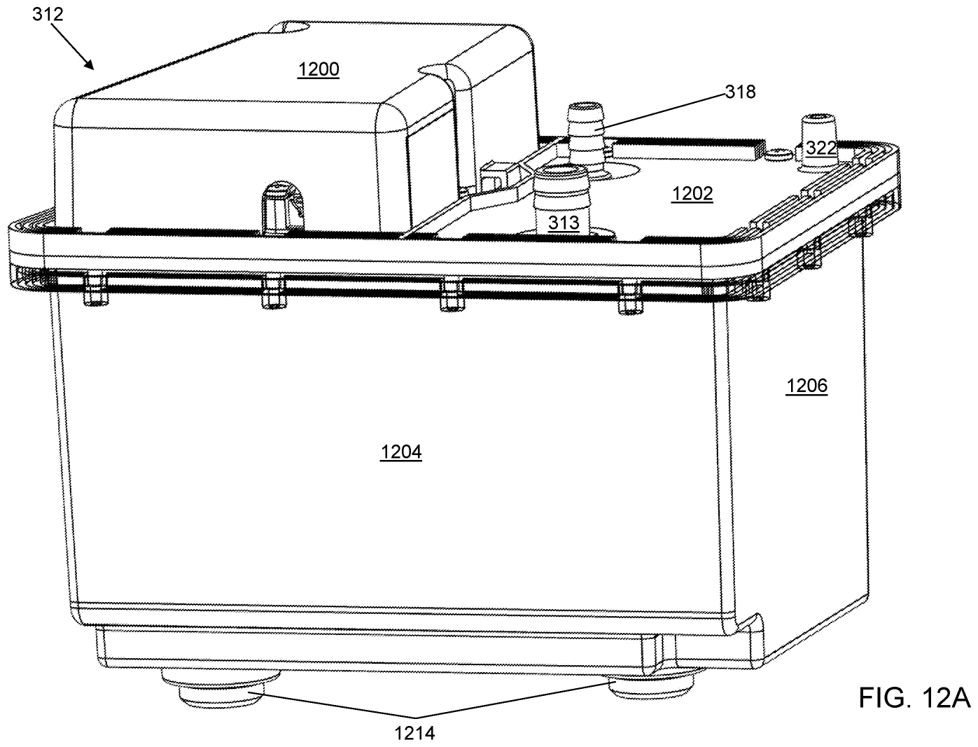

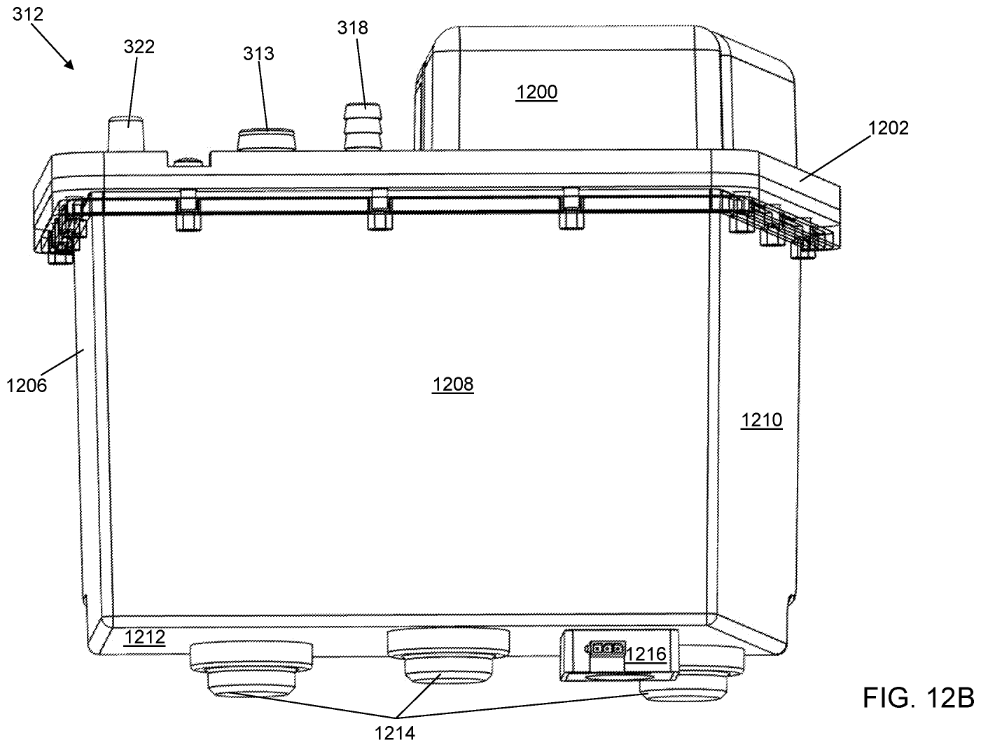

Referring to FIG. 12A, a top, right perspective view is shown of drain tank 312 in accordance with an illustrative embodiment. Referring to FIG. 12B, a bottom, left perspective view is shown of drain tank 312 in accordance with an illustrative embodiment. Drain tank 312 may include a pump motor/electronics housing 1200, a tank top wall 1202, a tank right side wall 1204, a tank back wall 1206, a tank left side wall 1208, a tank front wall 1210, and a tank bottom wall 1212. Tank top wall 1202, tank right side wall 1204, tank back wall 1206, tank left side wall 1208, tank front wall 1210, and tank bottom wall 1212 form a container to hold fluid that flows through drain connector tube 1000 from overflow drain tube 812. The container also holds fluid that flows through bin drain aperture wall 1002 and drain aperture wall 404 from within bin 202. The fluid flows through tank connector 314 that mounts to bin drain aperture wall 1002 and drain aperture wall 404. Drain connector tube 1000 is mounted within tank connector 314.

Tank connector 314 mounts to tank intake connector 313 that provides a conduit into the container formed by drain tank 312. Tank intake connector 313 forms a conduit through bin top wall 1202. Outtake conduit 320 mounts to tank outtake connector 318 and provides a conduit for transport of the fluid exterior of the container formed by drain tank 312. Tank outtake connector 318 forms a conduit through bin top wall 1202. Air conduit 316 mounts to tank air connector 322 and provides a conduit for air into and out of the container formed by drain tank 312.

Tank mounting feet 1214 protrude away from a bottom surface of tank bottom wall 1212. In the illustrative embodiment, tank mounting feet 1214 are sized and shaped to be held within bottom wall connectors 1100 to mount drain tank 312 within base compartment 118.

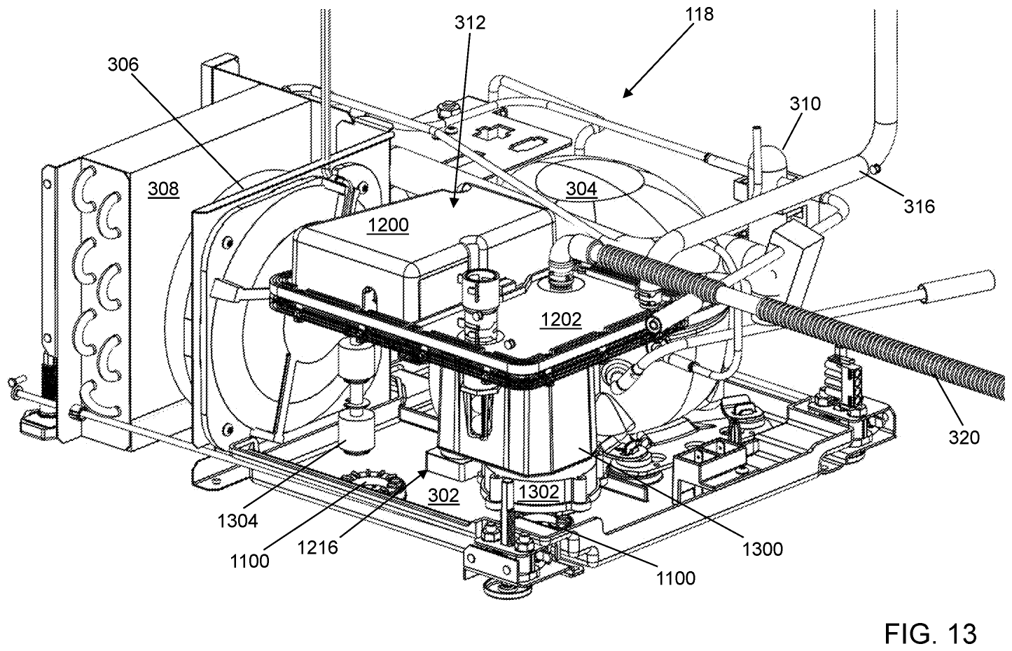

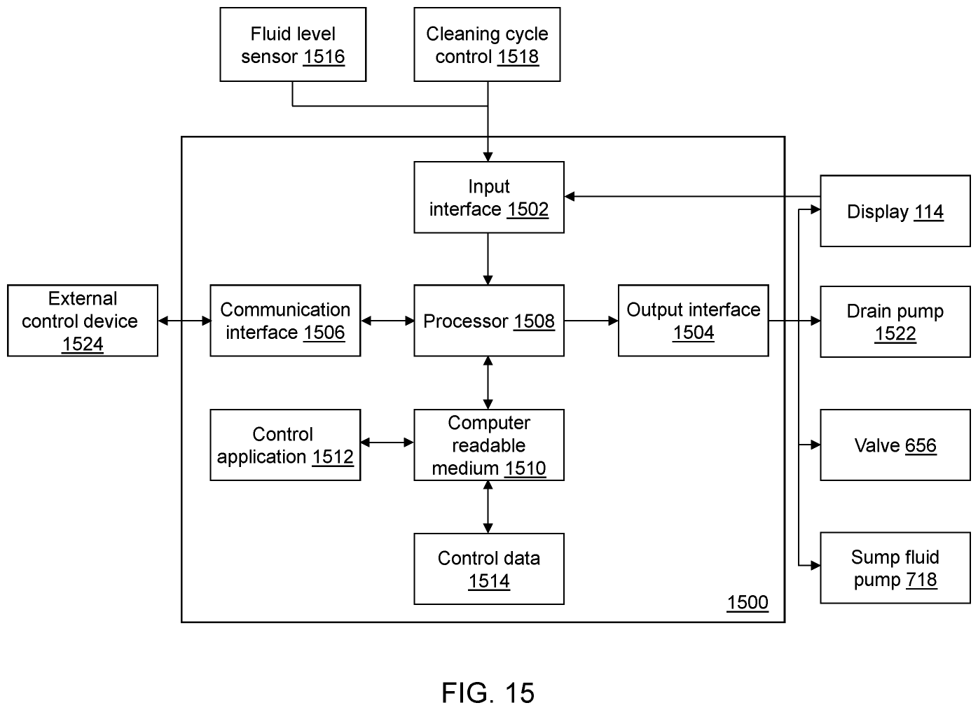

Referring to FIG. 13, a right, back perspective view is shown of base compartment 118 with sidewalls and tank bottom wall 1212 of drain tank 312 removed in accordance with an illustrative embodiment. A pump housing 1300 holds a drain pump 1522 (shown referring to FIG. 15) that includes a pump head 1302. Pump head 1302 is positioned just above a top surface of tank bottom wall 1212. When drain pump 1522 is controlled on by a drain system controller 1500 (shown referring to FIG. 15), drain pump 1522 evacuates the fluid held within drain tank 312 through tank outtake connector 318 that is connected to pump head 1302.

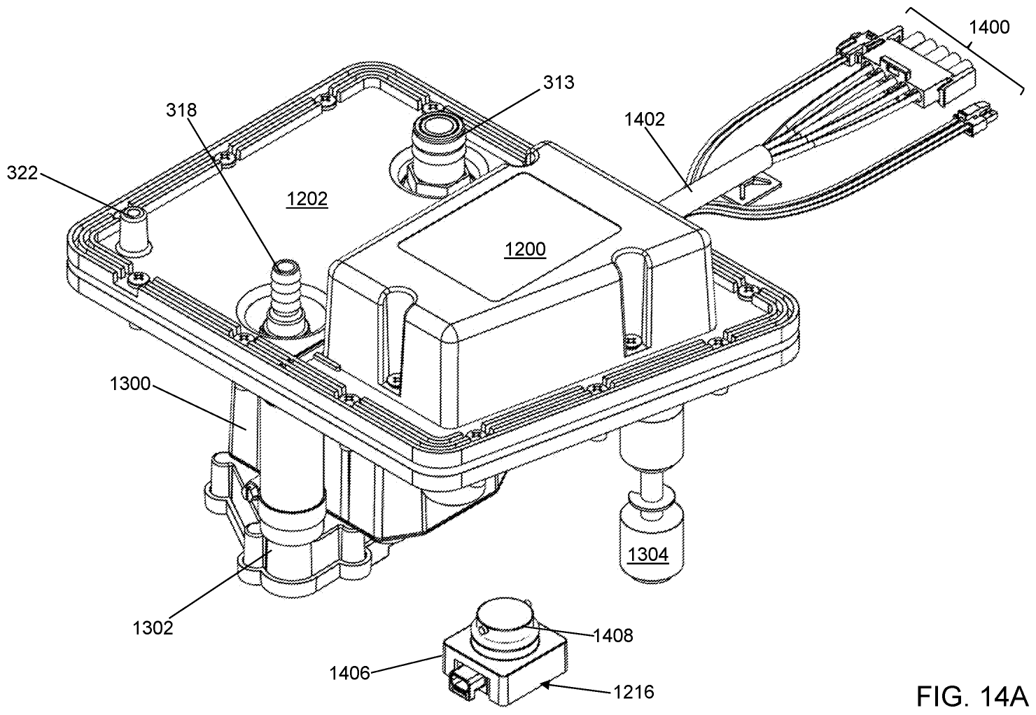

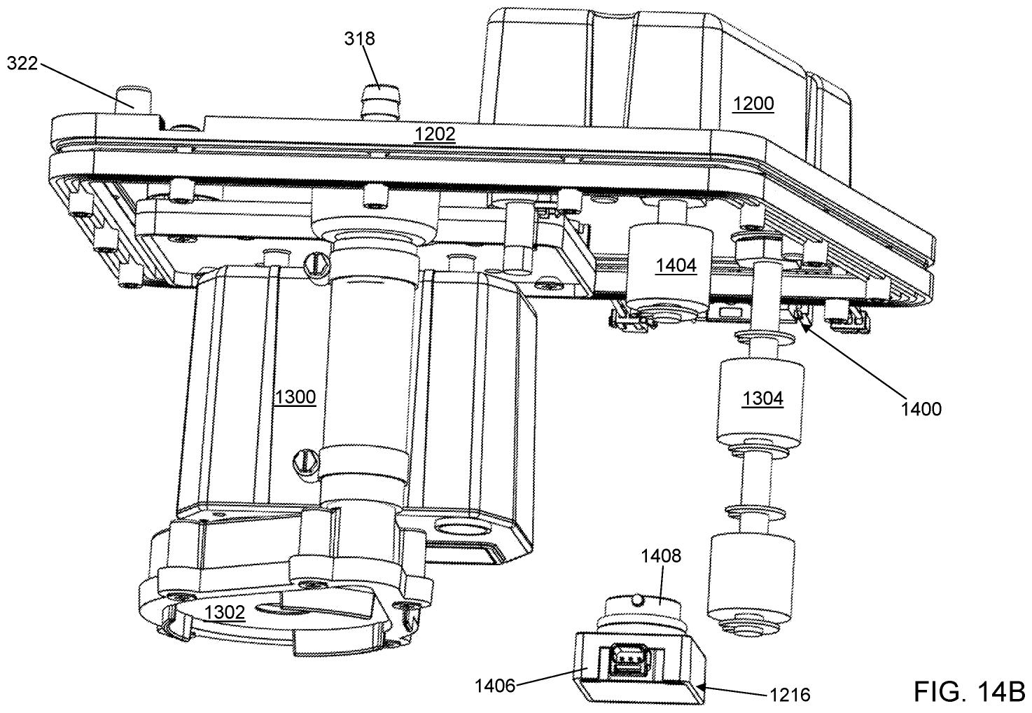

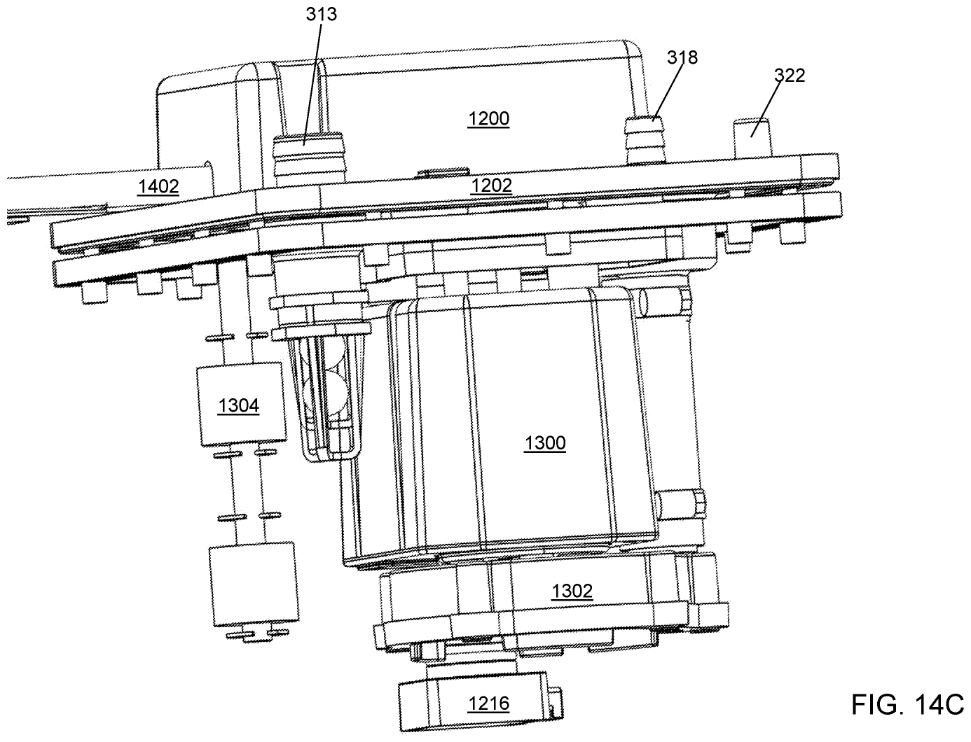

Referring to FIG. 14A, a top, left perspective view is shown of drain tank 312 with sidewalls and tank bottom wall 1212 of drain tank 312 removed in accordance with an illustrative embodiment. Referring to FIG. 14B, a bottom, left perspective view is shown of drain tank 312 with sidewalls and tank bottom wall 1212 of drain tank 312 removed in accordance with an illustrative embodiment. Referring to FIG. 14C, a bottom, back, right perspective view is shown of drain tank 312 with sidewalls and tank bottom wall 1212 of drain tank 312 removed in accordance with an illustrative embodiment.

A fluid level sensor 1516 (shown referring to FIG. 15) is mounted to drain tank 312 to determine a fluid level within drain tank 312. For illustration, fluid level sensor 1516 may include a float type switch, an ultrasonic sensor, or a capacitive sensor though other types of sensors may be used to detect a fluid level within drain tank 312. One or more sensors of the same or different type may be mounted to drain tank 312. For example, a float switch 1304 is mounted to extend downward from tank top wall 1202 within drain tank 312 to detect a fluid level within drain tank 312. As another example, an emergency float switch 1404 is mounted to extend downward from tank top wall 1202 within drain tank 312 to detect a fluid level within drain tank 312.

As yet another example, an ultrasonic sensor 1216 may be used. Ultrasonic sensor 1216 may include a sensor body 1406 and a sensor head 1408. Sensor head 1408 extends upward from sensor body 1406. Sensor body 1406 is mounted exterior of the container formed by the walls of drain tank 312 to extend downward from tank bottom wall 1212. Sensor head 1408 protrudes into the interior of drain tank 312 to extend upward from tank bottom wall 1212 and to contact the fluid held in drain tank 312. In an alternative embodiment, ultrasonic sensor 1216 may be mounted fully exterior of drain tank 312.

Electrical wires/connectors 1400 are connected to drain system controller 1500 to send and to receive signals to/from drain system controller 1500 to control drain pump 1522 on and off. Electrical wires/connectors 1400 are also connected to drain system controller 1500 to receive signals from fluid level sensor 1516 that indicate a fluid level within drain tank 312. For example, the fluid level may be indicated as high or empty. The high indicator may indicate that the fluid level exceeds a predetermined high level. The low or empty indicator may indicate that the fluid level is below a predetermined low level. Electrical wires/connectors 1400 are also connected to provide power to fluid level sensor 1516 and drain pump 1522. Electrical wires/connectors 1400 are held within an electrical wire conduit 1402 that is mounted to a side of pump motor/electronics housing 1200.

In the illustrative embodiment, pump motor/electronics housing 1200 an electrical control interface that is connected directly to emergency float switch 1404 and the pump motor. The emergency float switch 1404 is only connected through the electrical control interface to the pump motor. When emergency float switch 1404 detects a high fluid level in drain tank 312, emergency float switch 1404 triggers closing of an electrical circuit that triggers the pump motor to turn on and stay on until emergency float switch 1404 detects a low fluid level in drain tank 312. Thus, emergency float switch 1404 can independently control the drain pump without connectivity to drain system controller 1500 so that emergency float switch 1404 functions even if drain system controller 1500 fails. Drain system controller 1500 also interfaces with the electrical circuit to turn on/off the drain pump motor.

Referring to FIG. 15, a block diagram of drain system controller 1500 is shown in accordance with an illustrative embodiment. Drain system controller 1500 controls a flow of fluid into and out of drain tank 312. Drain system controller 1500 may include an input interface 1502, an output interface 1504, a communication interface 1506, a non-transitory computer-readable medium 1508, a processor 1510, a control application 1512, and control data 1514. Fewer, different, and/or additional components may be incorporated into drain system controller 1500.

Input interface 1502 provides an interface for receiving information from a user or another device for entry into drain system controller 1500 as understood by those skilled in the art. Input interface 1502 may interface with various input technologies including, but not limited to, fluid level sensor 1516 and a cleaning cycle control 1518. For example, fluid level sensor 1516 may produce a sensor signal value referred to as a measured fluid level value representative of a fluid level within drain tank 312. The input interface technology further may be accessible by drain system controller 1500 through communication interface 1506.

Input interface 1502 may further interface with various user input technologies including, but not limited to, a keyboard, a microphone, a mouse, display 114, a track ball, a keypad, one or more buttons, one or more switches, one or more knobs, etc. to allow the user to enter information into ice maker assembly 100 or to make selections presented in a user interface displayed on display 114.

Output interface 1504 provides an interface for outputting information for review by a user of drain system controller 1500 and/or for use by another application or device. For example, output interface 1504 may interface with various output technologies including, but not limited to display 114, drain pump 1522, valve 656, spray pump 718, etc. Drain system controller 1500 may have one or more output interfaces that use the same or a different output interface technology. The output interface technology further may be accessible by drain system controller 1500 through communication interface 1506.

The same interface may support both input interface 1502 and output interface 1504. For example, display 114 comprising a touch screen provides a mechanism for user input and for presentation of output to the user.

Communication interface 1506 provides an interface for receiving and transmitting data between devices using various protocols, transmission technologies, and media as understood by those skilled in the art. Communication interface 1506 may support communication using various transmission media that may be wired and/or wireless. Drain system controller 1500 may have one or more communication interfaces that use the same or a different communication interface technology. For example, drain system controller 1500 may support communication using an Ethernet port, a Bluetooth antenna, a telephone jack, a USB port, etc. Data and messages may be transferred between drain system controller 1500 and an external control device 1524 using communication interface 1506. For illustration, external control device 1524 may be a smart phone that may send a cleaning cycle start indicator to drain system controller 1500 through communication interface 1506 instead of using cleaning cycle control 1518.

Non-transitory computer-readable medium 1508 is an electronic holding place or storage for information so the information can be accessed by processor 1510 as understood by those skilled in the art. Computer-readable medium 1508 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disc (CD), digital versatile disc (DVD), . . . ), smart cards, flash memory devices, etc. Drain system controller 1500 may have one or more computer-readable media that use the same or a different memory media technology. For example, computer-readable medium 1508 may include different types of computer-readable media that may be organized hierarchically to provide efficient access to the data stored therein as understood by a person of skill in the art. Drain system controller 1500 also may have one or more drives that support the loading of a memory media such as a CD, DVD, an external hard drive, etc. One or more external hard drives further may be connected to drain system controller 1500 using communication interface 1506.

Processor 1510 executes instructions as understood by those skilled in the art. The instructions may be carried out by a special purpose computer, logic circuits, or hardware circuits. Processor 1510 may be implemented in hardware and/or firmware. Processor 1510 executes an instruction, meaning it performs/controls the operations called for by that instruction. The term “execution” is the process of running an application or the carrying out of the operation called for by an instruction. The instructions may be written using one or more programming languages, scripting languages, assembly languages, etc. Processor 1510 operably couples with input interface 1502, with output interface 1504, with communication interface 1506, and with computer-readable medium 1508 to receive, to send, and to process information. Processor 1510 may retrieve a set of instructions from a permanent memory device and copy the instructions in an executable form to a temporary memory device that is generally some form of RAM. Drain system controller 1500 may include a plurality of processors that use the same or a different processing technology.

Control application 1512 performs operations associated with controlling the operation of drain pump 1522, valve 656, and/or spray pump 718 to control a cleaning cycle and a fluid level within drain tank 312 optionally using data stored in control data 1514. For example, control data 1514 may include data that indicates a cleaning cycle duration, a number of rinse cycles, a sanitizing cycle duration, etc. The operations may be implemented using hardware, firmware, software, or any combination of these methods. Referring to the example embodiment of FIG. 15, control application 1512 is implemented in software (comprised of computer-readable and/or computer-executable instructions) stored in computer-readable medium 1508 and accessible by processor 1510 for execution of the instructions that embody the operations of control application 1512. Control application 1512 may be written using one or more programming languages, assembly languages, scripting languages, etc.

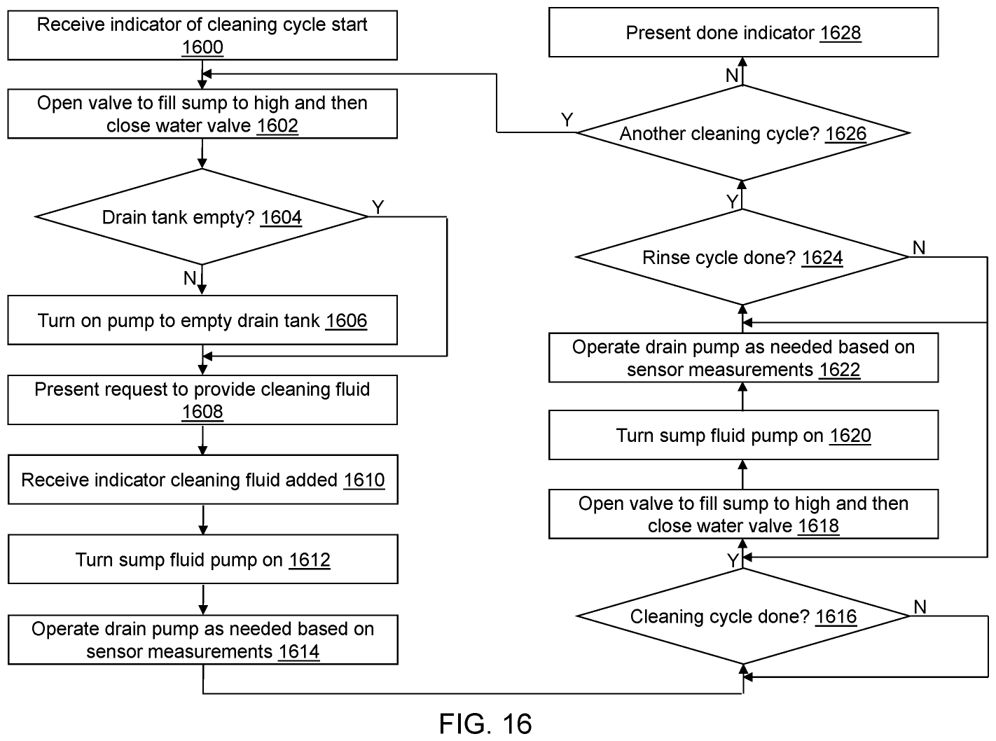

Referring to FIG. 16, a flow diagram is shown illustrating examples of operations performed by drain system controller 1500 in accordance with an illustrative embodiment. Additional, fewer, or different operations may be performed depending on the embodiment of control application 1512. The order of presentation of the operations of FIG. 16 is not intended to be limiting. Although some of the operational flows are presented in sequence, the various operations may be performed in various repetitions, concurrently (in parallel, for example, using threads), and/or in other orders than those that are illustrated. Control application 1512 may perform other operations, for example, associated with making ice, dispensing ice, etc.

In an operation 1600, a cleaning cycle start indicator may be received that indicates a user's desire to initiate a cleaning cycle for ice maker assembly 100. For example, the user may select an option to initiate a cleaning cycle using cleaning cycle control 1518. For example, cleaning cycle control 1518 may be one of the plurality of control buttons 116 or may be implemented using display 114. As understood by a person of skill in the art, cleaning cycle control 1518 may be implemented using a dial, knob, touch display, switch, etc.

In an operation 1602, valve 656 is controlled open to allow fluid to flow into sump housing 638. For example, valve 656 may be opened for a predefined period of time to allow the sump to fill to a predefined level as described previously. As another option, valve 656 may be opened until a sump fluid level sensor (not shown) indicates that the fluid level is high. The sump fluid level sensor may be used to indicate when valve 656 is opened and closed by drain system controller 1500.

In an operation 1604, a determination is made concerning whether or not drain tank 312 is empty based on a most recent signal from fluid level sensor 1516. When drain tank 312 is empty, processing continues in an operation 1608. When drain tank 312 is not empty, processing continues in an operation 1606.

In operation 1606, drain pump 1522 is turned on until fluid level sensor 1516 indicates that drain tank 312 is empty.

In operation 1608, a request is presented that the user pour cleaning fluid into cleaning fluid drawer 206. For example, a request may be presented using display 114. As another option a speaker (not shown) may be used to request that the cleaning fluid be added. The cleaning fluid may be a descaling fluid, a sanitizing fluid, etc. For example, in response to the request, the user pulls drawer 604 out from ice maker assembly 100 until the drawer receptacle is open a sufficient distance to avoid spillage. The fully open position may be restricted by a maximum extent of right slide 626 and of left slide 628. Transition tray 606 is included to provide a withdrawal distance that is greater than a depth of drawer 604. In alternative embodiments, transition tray 606 may not be included.

A user pours the fluid into the drawer receptacle of drawer 604 with or without splash guard tray 602. The fluid flows by gravity down the sloped walls of drawer 604 through top drawer drain 610 onto transition tray 606 and/or onto bottom tray 608. Drain tube 612 forms a nozzle that is inserted into drain aperture wall 660 formed through cover 654 when cleaning fluid drawer 206 is mounted to ice maker 200. The fluid is provided into the sump cavity through drain tube 612.

In an operation 1610, an indicator is received that indicates that the cleaning fluid has been added. For example, the user may select an option to indicate that the cleaning fluid has been added using cleaning cycle control 1518.

In an operation 1612, sump fluid pump 718 is controlled on to pump the fluid mixed with the cleaning fluid into sprayer conduit 800. Sprayer conduit 800 provides the mixed fluid to first sprayer conduit 802, second sprayer conduit 804, and third sprayer conduit 806 that are connected to the plurality of sprayers 652. The plurality of sprayers 652 spray the mixed fluid upward toward ice mold 640 through the plurality of nozzles 808.

In an operation 1614, drain pump 1522 is controlled on and off based on fluid levels received from fluid level sensor 1516.

In an operation 1616, a determination is made concerning whether or not the cleaning cycle is done. When the cleaning cycle is done, processing continues in an operation 1618. When the cleaning cycle is not done, processing continues in operation 1616 to await completion of the cycle. For example, the cleaning cycle may be done after a predefined period of time.

In operation 1618, valve 656 is opened to allow fluid to flow into sump housing 638. For example, valve 656 may be opened for a predefined period of time to allow the sump to fill to a predefined level as described previously.

In an operation 1620, sump fluid pump 718 is controlled on to pump the fluid into sprayer conduit 800. Sprayer conduit 800 provides the fluid to first sprayer conduit 802, second sprayer conduit 804, and third sprayer conduit 806 that are connected to the plurality of sprayers 652. The plurality of sprayers 652 spray the mixed fluid upward toward ice mold 640 through the plurality of nozzles 808.

In an operation 1622, drain pump 1522 is controlled on and off based on fluid levels received from fluid level sensor 1516.

In an operation 1624, a determination is made concerning whether or not the rinse cycle is done. When the rinse cycle is done, processing continues in an operation 1626. When the rinse cycle is not done, processing continues in operation 1618 or operation 1624. For example, the rinse cycle may be done after a predefined period of time or after a predefined number of repetitions of operations 1618 through 1622. The rinse cycle removes the cleaning fluid from ice maker 200.

In operation 1626, a determination is made concerning whether or not there is another cleaning cycle, such as a sanitization cycle, to perform. When there is another cleaning cycle, processing continues in operation 1602 to repeat operations 1602 through 1624. When there is not another cleaning cycle, processing continues in an operation 1628. A next cleaning cycle may be entered automatically or under control of the user using one of the plurality of control buttons 116 or display 114. Optionally, the next cleaning cycle may be entered using cleaning cycle control 1518.

In operation 1628, a done indicator may be presented to the user using display 114.

Drain system controller 1500 provides improved cleaning of drain tank 312 by activating drain pump 1522 at the start of each cleaning cycle to allow cleaning chemicals to remain in drain tank 312 until fluid level sensor 1516 indicates that a fluid level is high. Because drain tank 312 is empty at a beginning of the cleaning cycle, the cleaning fluid remains in drain tank 312 a longer period of time. Though illustrated in ice maker assembly 100, drain system controller 1500 may be used in other types of ice makers, in a steam oven, in a dishwasher, etc.

As used in this disclosure, the term “mount” is intended to define a structural connection between two or more structural components and includes join, unite, connect, couple, associate, insert, hang, hold, affix, attach, fasten, bind, paste, secure, bolt, screw, rivet, solder, weld, glue, adhere, form over, layer, and other similar terms. The phrases “mounted on” and “mounted to” include any interior or exterior portion of the components referenced. These phrases also encompass direct mounting (in which the referenced components are in direct contact) and indirect mounting (in which the referenced components are not in direct contact).

Components referenced as mounted to each other may further be integrally formed together, for example, using a molding process as understood by a person of skill in the art. Though described as including multiple structural components mounted to each other, components described herein may be formed of a single continuous piece of material, for example, by molding, or may be formed of multiple distinct pieces mounted together, for example, attached to each other using various fasteners including adhesives, screws, rivets, welded joints, etc. The components of ice maker assembly 100 may be formed of one or more materials, such as metal, glass, and/or plastic having a sufficient strength and rigidity and aesthetic value to provide the illustrated and/or described function.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, using “and” or “or” in the detailed description is intended to include “and/or” unless specifically indicated otherwise.

The foregoing description of illustrative embodiments of the disclosed subject matter has been presented for purposes of illustration and of description. It is not intended to be exhaustive or to limit the disclosed subject matter to the precise form disclosed, and modifications and variations are possible in light of the above teachings or may be acquired from practice of the disclosed subject matter. The embodiments were chosen and described in order to explain the principles of the disclosed subject matter and as practical applications of the disclosed subject matter to enable one skilled in the art to utilize the disclosed subject matter in various embodiments and with various modifications as suited to the particular use contemplated.

What is claimed is:

1. A non-transitory computer-readable medium having stored thereon computer-readable instructions that when executed by a drain control system cause the drain control system to:
receive a first indicator of start of a cleaning cycle;
in response to receipt of the first indicator, send a signal to turn on a drain pump mounted within a drain tank to evacuate a fluid stored in the drain tank when the drain tank is not indicated as empty;
receive a second indicator that a cleaning fluid has been provided to a storage tank; and
after the drain tank is indicated as empty, control circulation of the cleaning fluid within a drain system, wherein the drain system is configured to drain the cleaning fluid into the drain tank after circulating within the drain system, wherein the drain pump is controlled to turn on to evacuate the cleaning fluid from the drain tank based on a fluid level indicator generated by a fluid level sensor after the cleaning fluid drains into the drain tank.

2. The non-transitory computer-readable medium of claim 1, wherein the cleaning fluid is selected from the group consisting of a descaling fluid and a sanitizing fluid.

3. The non-transitory computer-readable medium of claim 1, wherein the storage tank is within an ice maker configured to form ice.

4. The non-transitory computer-readable medium of claim 3, wherein the storage tank is a sump of the ice maker.

5. The non-transitory computer-readable medium of claim 4, wherein circulation is controlled by triggering operation of a spray pump configured to spray the cleaning fluid upward into an ice mold.

6. The non-transitory computer-readable medium of claim 5, wherein, in response to receipt of the first indicator and before controlling circulation of the cleaning fluid, the computer-readable instructions further cause the drain control system to send a second signal to open a fluid valve to add second fluid to the sump.

7. The non-transitory computer-readable medium of claim 6, wherein the second signal is sent before receiving the second indicator.

8. The non-transitory computer-readable medium of claim 1, wherein circulation is controlled by initiating a fluid distribution cycle of an appliance.

9. The non-transitory computer-readable medium of claim 8, wherein the appliance is selected from the group consisting of an ice maker, a steam oven, and a dishwasher.

10. The non-transitory computer-readable medium of claim 1, wherein the computer-readable instructions further cause the drain control system to receive a second signal from the fluid level sensor that indicates a high-fluid level in the drain tank.

11. The non-transitory computer-readable medium of claim 10, wherein the drain pump is controlled to turn on to evacuate the cleaning fluid by computer-readable instructions that further cause the drain control system to send a third signal to turn on the drain pump in response to receipt of the second signal.

12. An appliance comprising:
a storage tank;
a drain tank;
a drain pump mounted within the drain tank;
a fluid level sensor configured to measure a fluid level of a fluid in the drain tank;
a drain system configured to direct the fluid from the storage tank to the drain tank;
a drain controller comprising
a processor; and
a computer-readable medium operably coupled to the processor, the computer-readable medium having computer-readable instructions stored thereon that, when executed by the processor, cause the drain controller to
receive a first indicator of start of a cleaning cycle of the appliance;
in response to receipt of the first indicator and when the fluid level sensor indicates that the drain tank is not empty, send a signal to turn on the drain pump to evacuate the fluid stored in the drain tank;
receive a second indicator that a cleaning fluid has been provided to the storage tank; and
after the drain tank is indicated as empty, control circulation of the cleaning fluid within the drain system, wherein the drain system is configured to drain the cleaning fluid into the drain tank after circulating within the drain system, wherein the drain pump is controlled to turn on to evacuate the cleaning fluid from the drain tank based on a fluid level indicator generated by the fluid level sensor after the cleaning fluid drains into the drain tank.

13. The appliance of claim 12, wherein the appliance is selected from the group consisting of an ice maker, a steam oven, and a dishwasher.

14. The appliance of claim 12, wherein circulation is controlled by initiating a fluid distribution cycle of the appliance.

15. The appliance of claim 12, wherein the fluid level sensor is selected from the group consisting of a float switch, a capacitive sensor, and an ultrasonic sensor.

16. The appliance of claim 12, further comprising a spray pump and an ice maker configured to form ice, wherein the storage tank is a sump of the ice maker, wherein circulation is controlled by triggering operation of the spray pump to spray the cleaning fluid upward into an ice mold of the ice maker.

17. The appliance of claim 16, further comprising a fluid valve, wherein, in response to receipt of the first indicator and before controlling circulation of the cleaning fluid, the computer-readable instructions further cause the drain controller to send a second signal to open the fluid valve to add second fluid to the sump.

18. The appliance of claim 12, wherein the computer-readable instructions further cause the drain controller to receive a second signal from the fluid level sensor that indicates a high-fluid level in the drain tank.

19. The appliance of claim 18, wherein the drain pump is controlled to turn on to evacuate the cleaning fluid by computer-readable instructions that further cause the drain controller to send a third signal to turn on the drain pump in response to receipt of the second signal.

20. The appliance of claim 12, further comprising a cleaning fluid drawer connected to the storage tank, wherein the cleaning fluid is provided from the cleaning fluid drawer to the storage tank.
